(19) United States
(12) Patent Application Publication
(10) Pub. No.: US 2021/0232673 A1
(43) Pub. Date: Jul. 29, 2021

(54) SECURING PHYSICAL ACCESS TO FILE CONTENTS

(71) Applicant: Citrix Systems, Inc., Fort Lauderdale, FL (US)

(72) Inventors: Anudeep Athlur, Bangalore (IN); Praveen Raja Dhanabalan, Bangalore (IN); Anuj Magazine, Bangalore (IN)

(21) Appl. No.: 16/774,262

(22) Filed: Jan. 28, 2020

(51) Int. Cl. G06F 21/44; G06F 16/176; G06F 40/109

(52) U.S. Cl. CPC G06F 21/44; G06F 40/109; G06F 16/176

(57) ABSTRACT

A computing system may perform a method that involves receiving an input indicating at least one person, other than a user of a computing device, is proximate to the computing device, determining that the person is within a threshold distance of the computing device based on the received input, and modifying an output of the computing device in response to determining that the person is within the threshold distance from the computing device, so as to inhibit the person from receiving content from the computing device.

### BACKGROUND

Various systems have been developed that allow client devices to access applications and/or data files over a network. Certain products offered by Citrix Systems, Inc., of Fort Lauderdale, Fla., including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a computing system performs a method that involves receiving data via an image capture device of a computing device in response to a request to access content of a file, where the data is indicative of at least one other person being within an area about the computing device in addition to a user of the computing device. The method further involves determining that the at least one other person is within a threshold distance from the computing device. The method also involves causing the computing device to modify an output of the file in response to the determined distance of the at least one other person being within the threshold distance from the computing device, so as to indicate that another person is in the area or to prevent receipt of the content of the file by the at least one other person.

In other of the disclosed embodiments, a computing system performs a method that involves receiving data via an image capture device of a computing device in response to a request to access content of a file, where the data indicative of at least one other person within an area about the computing device in addition to a user of the computing device, and determining at least one authorized person in addition to the user that is authorized to access the file. The method also further involves receiving an image of the at least one authorized person, processing the received data from the image capture device of the computing device and the image of the at least one authorized person to determine that the at least one other person is unauthorized to access the file, and causing the computing device to modify an output of the file in response to the determination that the at least one person is unauthorized to access the file, so as to indicate that another person is in the area or to prevent receipt of the content of the file by the at least one other person.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1 is a diagram illustrating an example of a system for managing physical access to contents of a file by persons around a user in accordance with the present disclosure;

FIG. 2A is a diagram of an example network computing environment in which some embodiments of a physical access management system disclosed herein may deployed;

FIG. 2B is a diagram illustrating how a network computing environment like that shown in FIG. 2A may be configured to deliver a computing environment from a server to a client;

FIG. 2C is a block diagram of an example of a computing system that may be used to implement one or more of the components of the computing environment shown in FIGS. 2A-B;

FIG. 3 is a schematic block diagram of an example of a cloud computing environment in which various aspects of the disclosure may be implemented;

FIG. 4A is a block diagram of an example system in which resource management services may manage and streamline access by clients to resource feeds (via one or more gateway services) and/or software-as-a-service (SaaS) applications;

FIG. 4B is a block diagram showing an example implementation of the system shown in FIG. 4A in which various resource management services as well as a gateway service are located within a cloud computing environment;

FIG. 4C is a block diagram similar to that shown in FIG. 4B but in which the available resources are represented by a single box labeled “systems of record,” and further in which several different services are included among the resource management services;

FIG. 5 is a diagram illustrating certain operations that may be performed by a file sharing system in accordance with some embodiments;

FIG. 6 is a diagram illustrating an example use of a physical access management system in accordance with some embodiments;

FIG. 7 is a diagram illustrating components of an example of a physical access management system in accordance with the present disclosure; and

FIG. 8 illustrates a flowchart of an example process of securing physical access to contents of a file by persons around the user in accordance with some embodiments.

### DETAILED DESCRIPTION

For purposes of reading the description of the various embodiments below, the following descriptions of the sections of the specification and their respective contents may be helpful:

Section A provides an introduction to example embodiments of a physical access management system for file contents;

Section B describes examples of a network environment and computing environment which may be useful for practicing embodiments described herein;

Section C describes example embodiments of systems and methods for delivering shared resources using a cloud computing environment;

Section D describes example embodiments of systems and methods for managing and streamlining access by clients to a variety of resources;

Section E describes example embodiments for providing file sharing over networks;

Section F provides a detailed description of example embodiments of a physical access management system for file contents; and

Section G describes example implementations of methods, systems, and computer-readable media in accordance with the present disclosure.

### A. Introduction to Illustrative Embodiments of a Physical Access Management System for File Contents

The inventors have recognized and appreciated that a user may be accessing sensitive or confidential information in areas where other persons may be able to “shoulder-surf” or eavesdrop and thus gain access to the information. As used herein, “shoulder surfing” refers to another person surreptitiously viewing a file being displayed to a user, such as by looking over the user's shoulder. At times, users may need to view documents or listen to audio in public spaces where there is a high likelihood of other persons being in close proximity to the user's device and being able to access the contents as well. For example, a user may be viewing a document using a laptop or a mobile device, and another person may be able to look over the user's shoulder to view the contents of the document. In another example, the user may be listening to a message using a speaker of a laptop or a mobile device, and another person near the user may be able to hear the contents of the message. Such risks may also exist in a work environment, where private and confidential information may be shared by a manager with an employee/user. Another unauthorized employee may look over the user's shoulder or be near the user to view or listen to the confidential information.

In accordance with some embodiments of the present disclosure, the user of the device on which the file contents are being output may be warned that another person might be able to view or listen to the contents based at least in part on a determined distance between the other person and the user's device. In some embodiments, the contents may be additionally or alternatively be altered (e.g., at least partially obscured or at least partially muted) based at least in part on the determined distance between the other person and the user's device. In some embodiments, a determination whether to warn the user and/or alter the contents may additionally or alternatively be based at least in part on a determination of the type of device (e.g., laptop versus smartphone) or type of component (e.g., headphones versus built-in device speaker) that is being used to output the content, and/or a setting, e.g., screen brightness or audio volume of such a device/component. In some embodiments, the determination whether to warn the user and/or alter the contents may additionally or alternatively be based at least in part on determination that the contents have been designated as confidential. In addition, in some embodiments, the determination whether to warn the user and/or alter the contents may additionally or alternatively be based at least in part on a determined identity of the other person and/or a determination that the other person is not authorized to access the contents of the file. Further, in some embodiments, the determination whether to warn the user and/or alter the contents may additionally or alternatively be based at least in part on an identity of the user and/or a relationship between the user and the other person, e.g., within an organizational hierarchy. Further, in some embodiments, a determination whether to warn the user and/or alter the contents may additionally or alternatively be based at least in part on a determined location of the user (e.g., in an office environment versus in a public area) and/or based at least in part on a number of persons who are determined to be in a vicinity of the user.

Conventional systems that detect shoulder-surfing typically determine, by analyzing an image captured by a camera, only whether another person is hovering over the user's shoulder, and then simply warn the user of the intrusion. By contrast, the present disclosure relates to a system that is capable of using of one or more additional pieces of information or factors to determine whether to issue such a warning, and that may further alter the contents of the file being output (e.g., by at least partially obscuring visual output or at least partially muting audio output) in addition to or in lieu of issuing such a warning. As noted above, for example, in some embodiments, a system in accordance with the present disclosure may additionally determine whether another person is within a threshold distance of the user's device, and determine to issue a warning and/or alter the contents being output based at least in part on such other person being within the threshold distance. Other examples of additional pieces of information or factors that may be taken into account when determining whether to issue a warning to the user and/or alter the contents being output are set forth above, and also described in more detail below.

In at least some embodiments, the systems disclosed herein may determine a threshold distance based on a determined degree of readability or accessibility of the file contents under the circumstances presented. For example, the threshold distance may be different for different file content types and/or different types of user devices being used to output the contents. For example, if the content being viewed by the user is text, then another person may have to be closer to the user's device to be able to read the text. If the content is an image, on the other hand, then another person may be able to view it from a farther distance. Similarly, a person may be able to view a larger device screen, such as with a laptop, from a farther distance than a smaller device screen, such as with a mobile device. Similarly, the threshold distance for an audio file may, for example, depend on the type of speaker(s) employed by the user's device (e.g., headphones versus built-in speakers) and/or the current output volume setting for the audio.

Additionally, in contrast to conventional systems, in at least some embodiments, the systems disclosed herein may determine whether another person who is able to access the file contents (e.g., by viewing or listening to them) is a person authorized to access the file, e.g., by comparing the person's face from the image captured by the user's device with images of persons authorized to the access file. Images of the authorized persons may, for example, be stored in a file access system database.

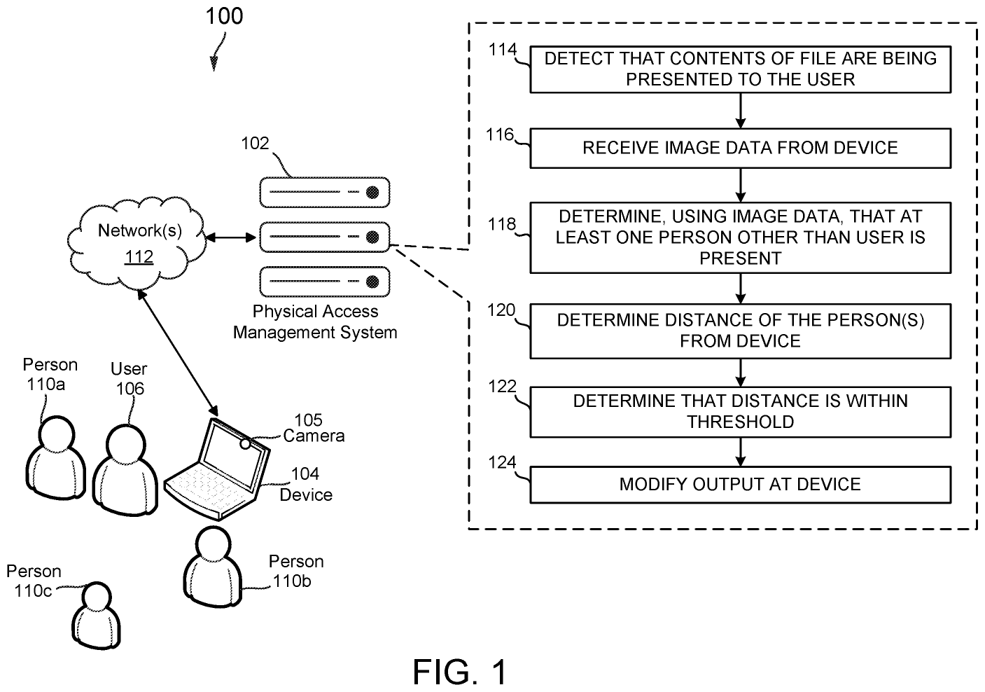

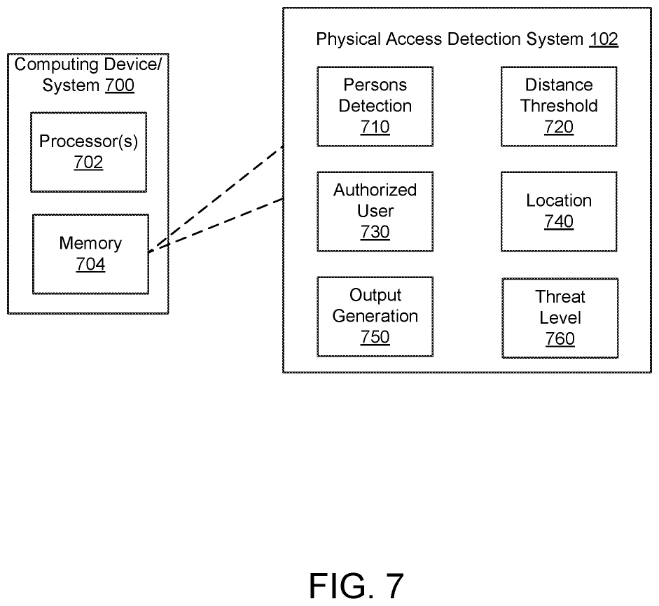

FIG. 1 is a diagram illustrating an example system 100 that is capable of detecting persons around a user who might able to access contents of a file, as well as warning a user when such a person is detected and/or modifying the contents being output, in accordance with some embodiments of the present disclosure. As shown in FIG. 1, the system 100 may include a physical access management system 102 (e.g., implemented by one or more servers) in communication, e.g., over one or more networks 112, with a device 104 that may be operated by a user 106 to access one or more files. Alternatively, in some embodiments, some or all of the functionality of the physical access management system 102 may be implemented on the device 104 itself. As shown in FIG. 1, the device 104 may include a camera 105 or other component(s) capable of capturing an image. As also shown, other persons 110a, 110b and 110c may be near the device 104, and may be able to view or listen to the file contents being output via the device 104. In some embodiments, the physical access management system 102 may include one or more of the components described below in connection with FIG. 7. The device 104 may, for example, correspond to any of the client devices 202 described herein, including but not limited to, a desktop, a laptop, a mobile device, a tablet, etc. The network(s) 112 may, for example, correspond to one or more of the networks 206 described herein.

In some embodiments, the user 106 may opt-in, provide permission, or otherwise authorize the physical access management system 102 to provide certain functionalities, such as monitoring the device 104 to detect when the user 106 accesses a file, accessing metadata associated with the file to determine whether the file is indicated as being restricted with respect to whom may access it, causing the camera 105 to capture an image of the user and the user's surroundings/background, outputting a warning to the user 106 via the device 104 when another user might be able to physically access (e.g., view or listen to) the contents of the file, and/or altering the output of the file contents on the device 104, etc.

As shown in the flow diagram of FIG. 1, the physical access management system 102 may detect (114) that contents of a file are being presented to the user or being accessed by the user via the device 104. The contents of the file may be presented to the user 106 by the device 104, for example, when the device 104 displays visual information represented by the file and/or by plays audio represented by the file. The contents may be displayed via a screen of the device 104, such as by displaying text, images, videos, etc., and/or by outputting audio via speakers of the device 104. In some embodiments, the physical access management system 102 may determine that the file is tagged as confidential, secure, sensitive, private or otherwise restricted to access by authorized users. Such determination may be made, for example, using metadata associated with the file. In such embodiments, in response to determining that the file is restricted, the physical access management system 102 may perform the next steps. The physical access management system 102 may detect the access of the file by the user 104 in a variety of ways. In some embodiments, for example, the physical access management system 102 may monitor the device 104 and identify that the file is open and in use (e.g., being displayed or played at the device 104). In some embodiments, the physical access management system 102 may additionally or alternatively determine that the user 106 downloaded the file at the device 104, and may monitor the device 104 after making such a determination to detect the user 106 accessing the file contents. The physical access management system 102 may determine that the user 106 downloaded a file in a variety of ways. For example, the physical access management system 102 may be part of a file access system (e.g., file sharing system 510 or file access system 610) or in communication with a file access system, and the physical access management system 106 may receive data from the file access system indicating when the user 106 downloads a file to the device 104. In another example, the physical access management system 102 may receive data from an email system or other messaging system indicating when the user 106 downloads a file attached to an email message or provided to the user 106 in other manners (via a chat messaging system, etc.). In another example, the physical access management system 102 may determine that the user 106 downloaded a file from a website.

Referring again to the flow diagram of FIG. 1, the physical access management system 102 may receive (116) image data from the device 104. The image data may correspond to an image taken by the camera 105, and the image may be of the user 106 and the user's surroundings/background. The image may represent other persons (e.g., 110a, 110b, 110c) near the user 106 and/or the device 104. In some embodiments, the physical access management system 102 may cause the device 104 to operate the camera 105 to capture the image in response to detecting that the device 104 is presenting contents of a file to the user.

The physical access management system 102 may determine (118), using the image data, that at least one person (e.g., the person 110a) is present in the image. The physical access management system 102 may process the image data using various processes, including but not limited to, computer vision techniques, facial detection, or others, to determine that a person other than the user 106 is represented in the image. In some embodiments, the physical access management system 102 may determine whether the person 110 is facing the device 104 and/or viewing the screen of the device 104 when the file contents are displayed by the device 104. To facilitate the physical access management system 102 authorizing the performance of one or more of the functionalities described herein, the user 106 may also provide an image of the user 106 that the physical access management system 102 can use to identify persons other than the user 106 represented in the image.

As indicated in the flow diagram, in some embodiments, the physical access management system 102 may determine (120) a distance between the person(s) and the device 104 using the image data. The physical access management system 102 may use various processes, including but not limited to, image analysis, computer vision techniques, object detection processing, and others, to determine the distance between the person 110 and the device 104. The physical access management system 102 may determine a distance between persons captured in the image, for example, a first distance corresponding to the person 110a, a second distance corresponding to the person 110b, and a third distance corresponding to the person 110c. The distance may be determined represented in feet, meters or any other unit of measurement.

The physical access management system 102 may determine (122) that the distance is within a threshold distance that might enable the person 110 to physically access the file, e.g., by viewing or listening to its contents. In some embodiments, the physical access management system 102 may identify the threshold distance based on a determined degree of readability or accessibility of the file contents, which may depend on the type of the file contents and/or the manner in which they are presented to the user 106. For example, if the content is being displayed to the user 106 and includes text, the physical access management system 102 may identify a first threshold distance, for example, one meter. That is, if the device 104 is displaying text and the person 110 is within one meter of the device 104, then the physical access management system 102 may determine that it is likely the person 110 is able to read the text. In some embodiments, the physical access management system 102 may additionally determine the font size of the text, and may adjust or identify a threshold distance accordingly. In some embodiments, the threshold distance may be determined using a rule-based system where the threshold distance corresponds to the size of the text being displayed. For example, if the font size is 12 point, then the threshold distance may be one meter. If the font size is larger than 12 point, on the other hand, then the threshold distance may be larger (e.g., two meters) because it is likely that the person 110 is able to read a larger font from farther away from the device 110.

In another example, when the content is being displayed to the user 106 and includes one or more images, the physical access management system 102 may determine a second threshold distance, for example, four meters. The second threshold distance may be reflective of the person 110 being able to see images from a farther distance than being able to read text displayed at the device 104. In some embodiments, the threshold distance may be determined using a rule-based system where the threshold distance corresponds to the size of the image being displayed. In another example, when the content includes audio and is being outputted by one or more speakers of the device 104, the physical access management system 102 may determine a third threshold distance, for example, three meters. In some embodiments, the third threshold distance may be determined based on the volume of the audio being output by the speaker(s). In some embodiments, the threshold distance may be determined using a rule-based system where the threshold distance corresponds to the output volume. For example, the third threshold distance may be larger when the volume of the audio being output by the speaker(s) is higher, and the third threshold distance may be smaller when the volume of the audio is lower. That is, when the audio is being listened to at a loud volume, the person 110 can be farther away from the device 104 and still be able to hear the audio, whereas if the audio is being listened to a low volume then the person 110 has to be close to the device 104 to be able to hear the audio. The third threshold distance may additionally or alternatively be determined based on whether the user 106 is using headphones to listen to the audio. The third threshold distance may be close to zero meters in that case, indicating that the person 110 is likely unable to hear the audio regardless of how close the person 110 is to the device 104.

The physical access management system 102 may also determine the threshold distance based on the type of device 104 or, more specifically, the screen size of the device 104. The threshold distance for other persons being able to view text or images displayed at a larger screen, such as desktop monitor or laptop screen, may be greater than the threshold distance for other persons being able to view text or images displayed at a smaller screen, such as a tablet or mobile device. For example, the threshold distance for a laptop displaying text may be 1.5 meters and the threshold distance for a mobile device displaying text may be 1 meter. In another example, the threshold distance for a laptop displaying images may be 4 meters and the threshold distance for a mobile device displaying images may be 2 meters. It should be understood that, in some implementations, the threshold distance may depend on the screen size of the device 104, rather than the device type. That is a laptop with a screen size of 15 inches may have a greater threshold distance compared to that of a laptop with a screen size of 11 inches.

Based on the type of file contents, the physical access management system 102 may identify an appropriate threshold distance to determine whether the person 110 is close enough to the device 104 to be able to view or listen to the file contents. Upon determining that the person 110 is within the threshold distance of the device 104, the physical access management system 102 may modify (124) an output of the device 104. In some embodiments, for example, the physical access management system 102 may cause the device 104 to output a warning, a message, a dialog box or another indication informing the user 106 that other persons in proximity of the device might be able to access the file. In some embodiments, the physical access management system 102 may additionally or alternatively cause the device 104 to alter the presentation of the file contents.

For example, in the case where the content is being displayed at the device 104, the physical access management system 102 may cause the device 104 to display the indication to the user 106 and/or alter the display of the file contents. In some embodiments, the physical access management system 102 may cause the device 104 to blur the display screen so that the file contents cannot be viewed by the user 104 or the person 110. In other embodiments, the physical access management system 102 may cause the device 104 to lower the display screen brightness, or to stop displaying the file contents by minimizing the application window, sending the application window to the background behind other application windows or by other actions.

In the case where the content is being outputted using the speakers of the device 104, for example, the physical access management system 102 may cause the device 104 to stop playing the audio. In other embodiments, the physical access management system 102 may cause the device 104 to lower the speaker/output volume. Additionally or alternatively, the physical access management system 102 may play a warning, a message or another indication informing the user 106 that other persons are able to hear the audio. Additionally or alternatively, the physical access management system 102 may display an indication at the device 104 informing the user 106 that other persons are able to hear the audio. In some embodiments, the physical access management system 102 may determine that the user 104 is using headphones to listen to the audio content, and may not perform the steps to detect other persons near the device 104, or not modify the output of the device even if such persons are detected.

The user 106 may provide an input via the device 104 acknowledging the warning by the system. The user 106 may, for example, provide an input indicating that the system should continue presenting the file contents, and the physical access management system 102 may cause the device 104 to continue display or playback of the file contents in response to receiving such input.

In some embodiments, the physical access management system 102 may continuously monitor the device 104 to determine whether other persons might be able to physically access (e.g., view or listen to) the file contents. For example, the physical access management system 102 may cause the camera 105 to capture an image periodically while the user 106 continues to access the file, and may perform the steps 114-124 to detect whether one or more persons have come near the device 104, are likely able to physically access the file contents, and warn the user 106 accordingly.

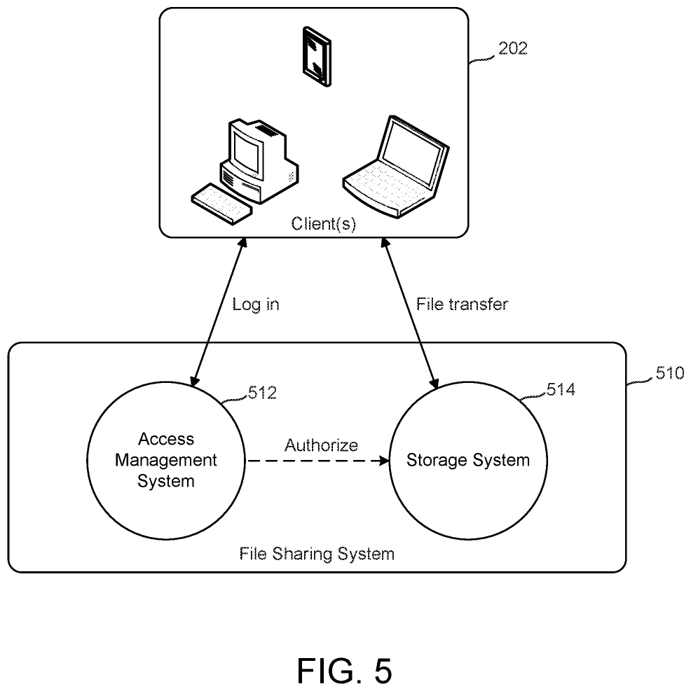

In some embodiments, the physical access management system 102 may determine whether the person 110 detected near the user 106 is authorized to access the file. The physical access management system 102 may, for example, use metadata associated with the file and/or information stored at a file access system (e.g., a file sharing system 510—shown in FIG. 5) to determine other users that are authorized to access the file. The physical access management system 102 may retrieve images of the authorized users from a database and compare them with the image captured by the device 104 to determine if the person 110 is authorized to access the file. For example, multiple employees of an organization may be authorized to view a confidential document, and one of the employees/user 106 may be viewing the file using the device 104 while another authorized employee/person 110 looks over the user 106 shoulder to view the document. The physical access management system 102 may retrieve images of the authorized employees from an organization database, compare the images with the image captured by the device 104 (using facial recognition or other image analysis techniques), and determine that the person 110 in the image is authorized to view the document. In that case, the physical access management system 102 may not output a warning to the user 106 and the device 104 may continue displaying the document.

In some embodiments, the physical access management system 102 may determine the location of the user 106/device 104 prior to detecting persons near the device 104 that might be able to access the file. If the location indicates that the user 106 is in a public area, such as an airport, bus station or other areas, for example, then the physical access management system 102 may perform the steps 112-124 to detect persons 110 near the device 104. If the location indicates that the user 106 is in a private area, such as the user's home or user's private office, on the other hand, then the physical access management system 102 may not perform the steps 112-124.

In some embodiments, the physical access management system 102 may determine whether the persons 110 are authorized to access the file if the user 106/device 104 is located in the user's work environment, making it more likely that other authorized users may be viewing or listening to the file contents along with the user 106. In other words, the physical access management system 102 may not perform the steps to determine whether the persons 110 are authorized to access the file if the user 106/device 104 is located in a public area or an area where it is less likely that other authorized users are also accessing the file along with the user 106.

Although the illustrated example shows one device 104, it should be understood that the user 106 may be using more than one device 104 at a time to access files or for other actions. For example, the user 106 may be using a laptop to view content and a mobile device to listen to content. In some embodiments, the physical access management system 102 may use images captured by both the laptop and the mobile device to detect persons near the user 106, determine whether the persons are close enough to view the content on the laptop or listen to the content outputted by the mobile device, and inform the user 106 accordingly. In other embodiments, the physical access management system 102 may determine that the content outputted by the mobile device is not confidential or restricted, but still use images captured by the mobile device to detect persons near the user 106 that may be able to view the content displayed at the laptop.

Additional details and example implementations of embodiments of the present disclosure are set forth below in Section F, following a description of example systems and network environments in or with which such embodiments may be deployed.

### B. Network and Computing Environment

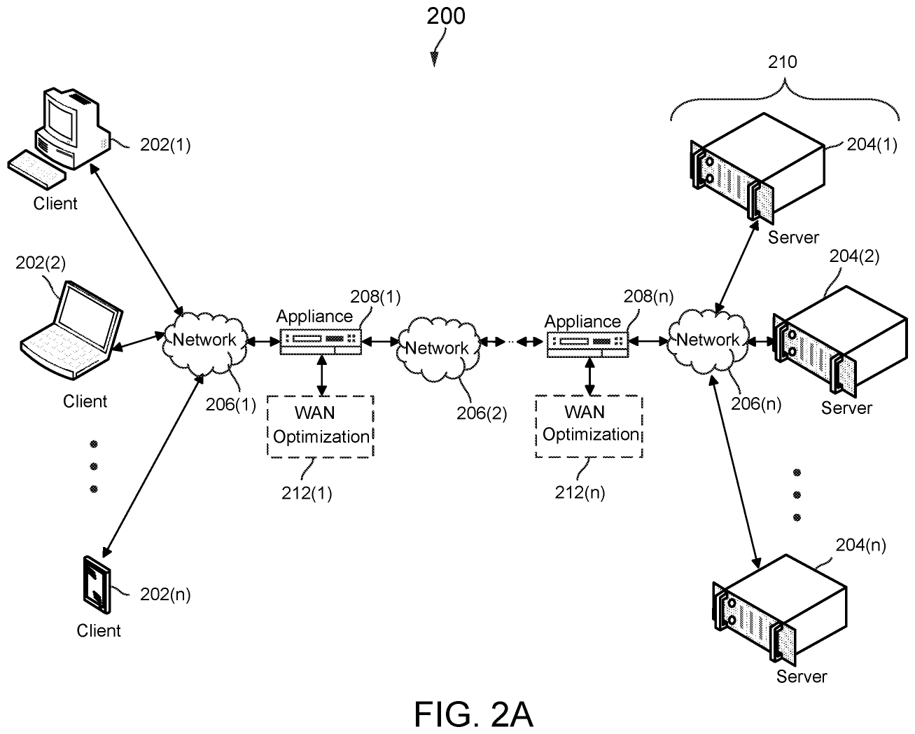

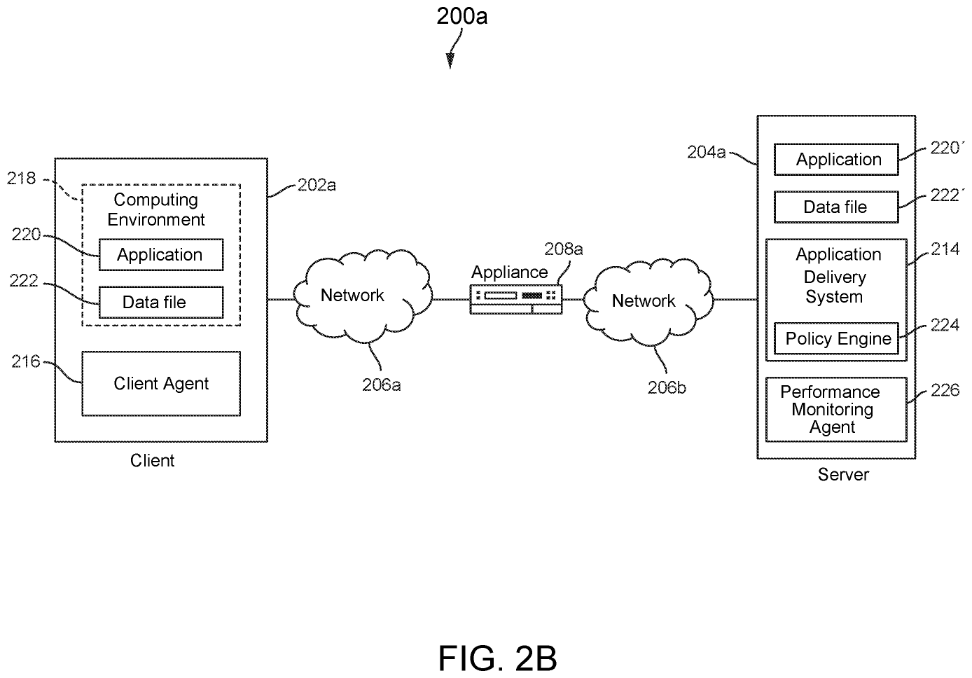

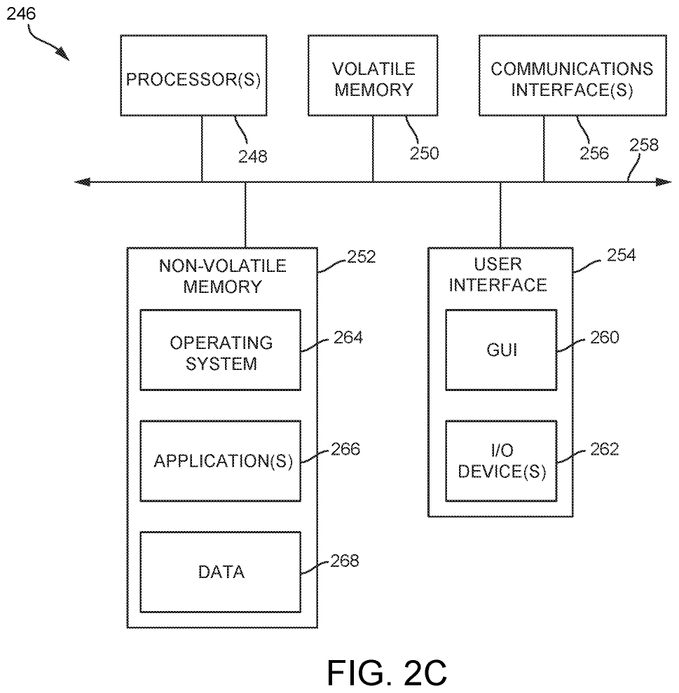

Referring to FIG. 2A, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208).

Although the embodiment shown in FIG. 2A shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may each be a private network such as a local area network (LAN) or a company Intranet, while the network 206(2) may be a public network, such as a wide area network (WAN) or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 2A, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, each appliance 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one or more of the appliances 208 may be implemented as network devices sold by Citrix Systems, Inc., of Fort Lauderdale, Fla., such as Citrix Gateway™ or Citrix ADC™.

As shown in FIG. 2A, in some embodiments, groups of the servers 204 may operate as one or more server farms 210. The servers 204 of each such server farm 210 may be logically grouped, and may either be geographically co-located (e.g., on premises) or geographically dispersed (e.g., cloud based) from the clients 202 and/or other servers 204. In some embodiments, as explained in more detail below, one or more server farms 210 may execute one or more applications on behalf of one or more of clients 202 (e.g., as an application server system) and/or may facilitate the sharing of files between the clients 202 (e.g., as a file sharing system), although other uses are possible, such as a file server, gateway server, proxy server, or other similar server uses. In some embodiments, two or more server farms 210 may communicate with one another, e.g., via respective appliances 208 connected to the network 206(2), to allow multiple server-based processes to interact with one another.

As also shown in FIG. 2A, in some embodiments, one or more of the appliances 208 may include, be replaced by, or be in communication with, one or more additional appliances, such as WAN optimization appliances 212(1)-212(n), referred to generally as WAN optimization appliance(s) 212. For example, each WAN optimization appliance 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller. In some embodiments, for example, one or more of the appliances 212 may be implemented as products sold by Citrix Systems, Inc., of Fort Lauderdale, Fla., such as Citrix SD-WAN™ or Citrix Cloud™.

Referring to FIG. 2B, an example network environment 200a for delivering and/or operating a computing environment on a client 202a is shown. As shown in FIG. 2B, in some embodiments, a client 202a may include a computing environment 218, and a server 204a may include an application delivery system 214 for delivering a computing environment, application, and/or data files to one or more clients 202.

In some embodiments, each client 202 may additionally include a client agent 216 for establishing and exchanging communications with the appliance 208 and/or the server(s) 204 via a network 206. The client 202a may, for example, have installed and/or execute one or more applications that are in communication with the network 206a. In some embodiments, the client agent 216 may intercept network communications from a network stack used by the one or more applications. For example, the client agent 216 may intercept a network communication at any point in a network stack and redirect the network communication to a destination desired, managed, and/or controlled by the client agent 216, for example, to intercept and redirect a transport layer connection to an IP address and port controlled and/or managed by the client agent 216. The client agent 216 may thus, in some embodiments, transparently intercept any protocol layer below the transport layer, such as the network layer, and any protocol layer above the transport layer, such as the session, presentation, or application layers. The client agent 216 may, for example, interface with the transport layer to secure, optimize, accelerate, route, and/or load-balance any communications provided via any protocol carried by the transport layer.

In some embodiments, the client agent 216 may be implemented as an Independent Computing Architecture (ICA) client developed by Citrix Systems, Inc. The client agent 216 may perform acceleration, streaming, monitoring, and/or other operations. For example, the client agent 216 may accelerate streaming an application from the server 204a to the client 202a. The client agent 216 may also perform endpoint detection/scanning and/or collect endpoint information about the client 202a for the appliance 208a and/or the server 204a. The appliance 208a and/or the server 204a may use the collected information to determine and provide access, authentication, and/or authorization control of the client's connection to the network 206a. For example, the client agent 216 may identify and determine one or more client-side attributes, such as: the operating system and/or a version of an operating system, a service pack of the operating system, a running service, a running process, a file, presence or versions of various applications of the client, such as antivirus, firewall, security, and/or other software.

The computing environment 218 may, for example, execute or operate an application 220 that accesses, processes and/or uses a data file 222. The computing environment 218, application 220 and/or data file 222 may be delivered via an appliance 208a and/or the server 204a.

The appliance 208a may accelerate delivery of all or a portion of the computing environment 218 to the client 202a, for example by the application delivery system 214. For example, the appliance 208a may accelerate delivery of a streaming application 220′ and data file 222′ processable by the application 220 from a data center to a remote user location by accelerating transport layer traffic between the client 202a and the server 204a. Such acceleration may be provided by one or more techniques, such as: 1) transport layer connection pooling, 2) transport layer connection multiplexing, 3) transport control protocol buffering, 4) compression, 5) caching, or other techniques. The appliance 208a may also provide load balancing of servers 204 in a server farm 210 (shown in FIG. 2A) to process requests from the clients 202, act as a proxy or access server to provide access to the one or more servers 204, provide security and/or act as a firewall between the clients 202 and the servers 204, provide Domain Name Service (DNS) resolution, provide one or more virtual servers or virtual internet protocol servers, and/or provide secure virtual private network (VPN) connections from the clients 202 to the servers 204, such as a secure socket layer (SSL) VPN connection and/or provide encryption and decryption operations.

The application delivery system 214 may deliver the computing environment 218 to a user (e.g., client 202a), remote or otherwise, based on authentication and authorization policies applied by a policy engine 224. A remote user may obtain a computing environment and access to server stored applications 220′ and data files 222′ from any network-connected device (e.g., the client 202a). For example, the appliance 208a may request an application 220′ and data file 222′ from the server 204a. In response to the request, the application delivery system 214 and/or the server 204a may deliver the application 220′ and data file 222′ to the client 202a, for example via an application stream to operate in the computing environment 218 on client the 202a, or via a remote-display protocol or otherwise via remote-based or server-based computing. In an embodiment, application delivery system 214 may be implemented as any portion of the Citrix Workspace™ and Citrix Virtual Apps and Desktops™ by Citrix Systems, Inc., of Fort Lauderdale, Fla.

The policy engine 224 may control and manage the access to, and execution and delivery of, applications. For example, the policy engine 224 may determine the one or more applications a user or client 202 may access and/or how the application should be delivered to the user or client 202, such as a server-based computing, streaming or delivering the application locally to the client 202 for local execution.

For example, in operation, the client 202a may request execution of an application (e.g., application 220′) and the application delivery system 214 of the server 204a may determine how to execute the application 220′, for example based upon credentials received from the client 202a and a user policy applied by the policy engine 224 associated with the credentials. For example, the application delivery system 214 may enable the client 202a to receive application-output data generated by execution of the application on the server 204a, may enable client the 202a to execute the application 220 locally after receiving the application from the server 204a, or may stream the application via one or more networks 206a, 206b to the client 202a. For example, in some embodiments, the application 220 may be a server-based or a remote-based application executed on the server 204a on behalf of the client 202a. The server 204a may display output to the client 202a using a thin-client or remote-display protocol, such as the Independent Computing Architecture (ICA) protocol by Citrix Systems, Inc. The application 220 may be any application related to real-time data communications, such as applications for streaming graphics, streaming video and/or audio or other data, delivery of remote desktops or workspaces or hosted services or applications, for example infrastructure as a service (IaaS), workspace as a service (WaaS), software as a service (SaaS) or platform as a service (PaaS).

As shown, one or more servers 204 may also include a performance monitoring service or agent 226. In some embodiments, a dedicated one or more servers 204 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on one or more clients 202 (e.g., the client agent 216), one or more servers 204 (e.g., the agent 226) and/or one or more appliances 208 and/or 212 (agent not shown). In general, the monitoring agents (e.g., agent 216 and/or agent 226) may execute transparently (e.g., in the background) to any application and/or user of the device. In some embodiments, the monitoring agent 226 may be implemented as Citrix Analytics™ by Citrix Systems, Inc., of Fort Lauderdale, Fla.

The monitoring agents may, for example, monitor, measure, collect, and/or analyze data on a predetermined frequency, based upon an occurrence of given event(s), or in real time during operation of the network environment 200a. The monitoring agents may monitor resource consumption and/or performance of hardware, software, and/or communications resources of the clients 202, networks 206, appliances 208 and/or 212, and/or servers 204. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents may provide application performance management for the application delivery system 214. For example, based upon one or more monitored performance conditions or metrics, the application delivery system 214 may be dynamically adjusted, for example periodically or in real-time, to optimize application delivery by the servers 204 to the clients 202 based upon network environment performance and conditions.

In the described embodiments, the clients 202, servers 204, and appliances 208 and/or 212 (appliances 212 are shown in FIG. 2A) may be deployed as and/or executed on any type and form of computing device, such as any desktop computer, laptop computer, rack-mounted computer, or mobile device capable of communication over at least one network and performing the operations described herein. For example, the clients 202, servers 204 and/or appliances 208 and/or 212 may each correspond to one computing system, a plurality of computing systems, or a network of distributed computing systems such as computing system 246 shown in FIG. 2C.

As shown in FIG. 2C, the computing system 246 may include one or more processors 248, volatile memory 250 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 may include a graphical user interface (GUI) 260 (e.g., a touchscreen, a display, etc.) and one or more input/output (I/O) devices 262 (e.g., a mouse, a keyboard, camera, etc.). The non-volatile memory 252 may store an operating system 264, one or more applications 266, and data 268 such that, for example, computer instructions of the operating system 264 and/or applications 266 are executed by the processor(s) 248 out of the volatile memory 250. Data may be entered using an input device of the GUI 260 or received from I/O device(s) 262. Various elements of the computing system 246 may communicate via communication the bus 258. The computing system 246 as shown in FIG. 2C is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 248 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 256 may include one or more interfaces to enable the computing system 246 to access a computer network such as a LAN, a WAN, or the Internet through a variety of wired and/or wireless or cellular connections.

As noted above, in some embodiments, one or more computing systems 246 may execute an application on behalf of a user of a client computing device (e.g., a client 202), may execute a virtual machine, which provides an execution session within which applications execute on behalf of a user or a client computing device (e.g., a client 202), such as a hosted desktop session, may execute a terminal services session to provide a hosted desktop environment, or may provide access to a computing environment including one or more of: one or more applications, one or more desktop applications, and one or more desktop sessions in which one or more applications may execute.

### C. Systems and Methods for Delivering Shared Resources Using a Cloud Computing Environment

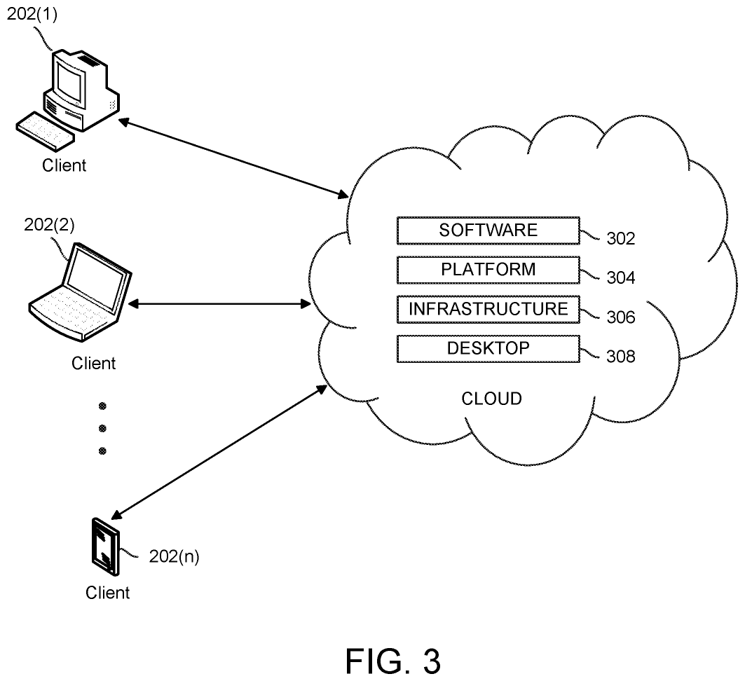

Referring to FIG. 3, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 202 (such as those described above) are in communication with a cloud network 304. The cloud network 304 may include back-end platforms, e.g., servers, storage, server farms and/or data centers. The clients 202 may correspond to a single organization/tenant or multiple organizations/tenants. More particularly, in one example implementation, the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 202 or the enterprise/tenant. The servers may be located off-site in remote geographical locations or otherwise.

The cloud computing environment 300 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 202. In some embodiments, the cloud computing environment 300 may include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 302, Platform as a Service (PaaS) 304, Infrastructure as a Service (IaaS) 306, and Desktop as a Service (DaaS) 308, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### D. Systems and Methods for Managing and Streamlining Access by Client Devices to a Variety of Resources

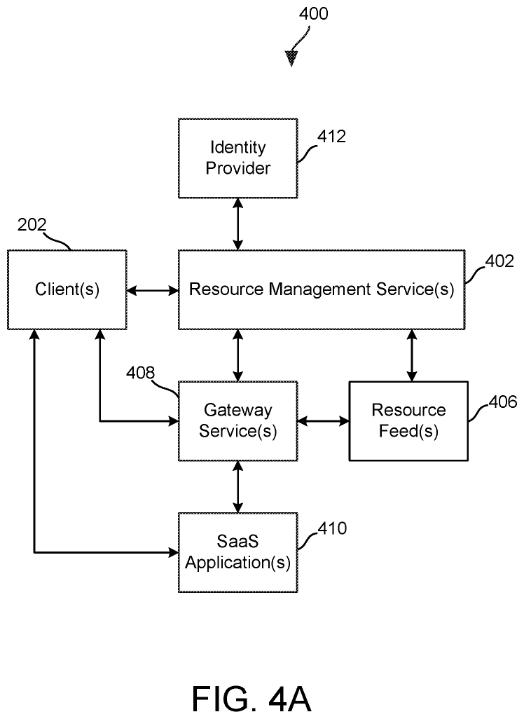

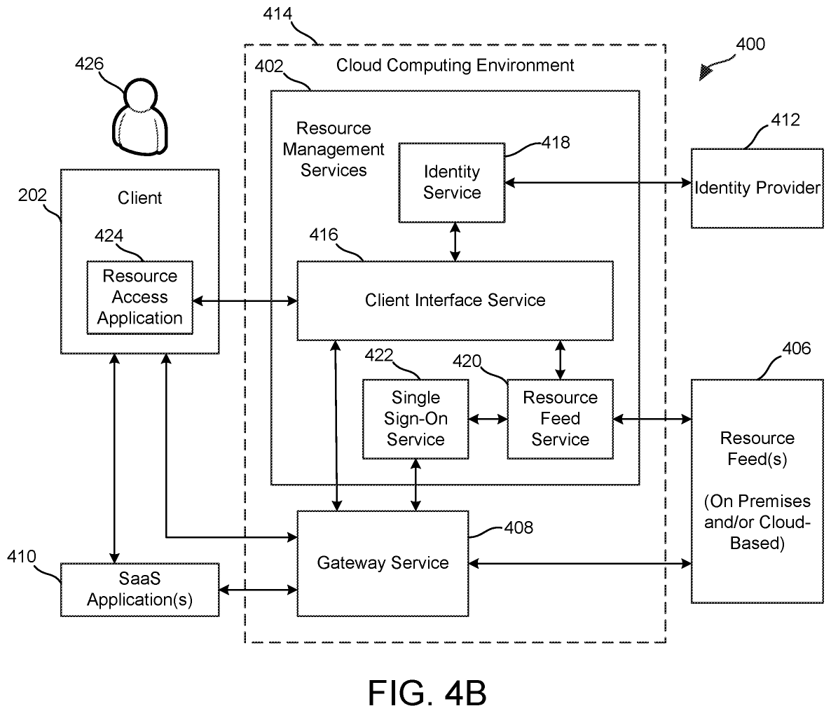

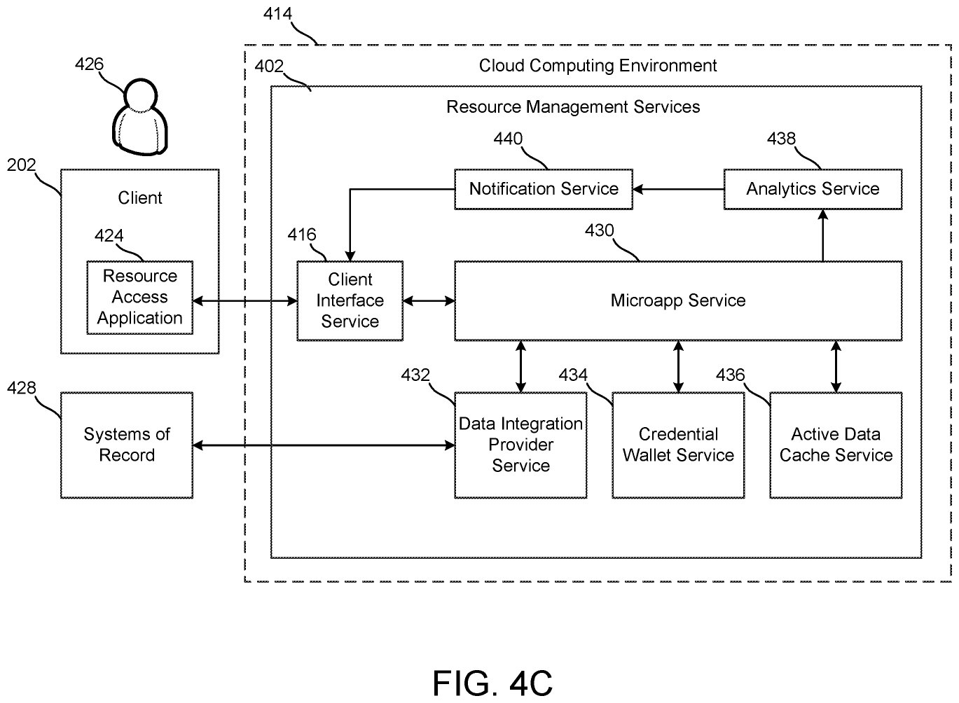

FIG. 4A is a block diagram of an example system 400 in which one or more resource management services 402 may manage and streamline access by one or more clients 202 to one or more resource feeds 406 (via one or more gateway services 408) and/or one or more software-as-a-service (SaaS) applications 410. In particular, the resource management service(s) 402 may employ an identity provider 412 to authenticate the identity of a user of a client 202 and, following authentication, identify one of more resources the user is authorized to access. In response to the user selecting one of the identified resources, the resource management service(s) 402 may send appropriate access credentials to the requesting client 202, and the client 202 may then use those credentials to access the selected resource. For the resource feed(s) 406, the client 202 may use the supplied credentials to access the selected resource via a gateway service 408. For the SaaS application(s) 410, the client 202 may use the credentials to access the selected application directly.

The client(s) 202 may be any type of computing devices capable of accessing the resource feed(s) 406 and/or the SaaS application(s) 410, and may, for example, include a variety of desktop or laptop computers, smartphones, tablets, etc. The resource feed(s) 406 may include any of numerous resource types and may be provided from any of numerous locations. In some embodiments, for example, the resource feed(s) 406 may include one or more systems or services for providing virtual applications and/or desktops to the client(s) 202, one or more file repositories and/or file sharing systems, one or more secure browser services, one or more access control services for the SaaS applications 410, one or more management services for local applications on the client(s) 202, one or more internet enabled devices or sensors, etc. Each of the resource management service(s) 402, the resource feed(s) 406, the gateway service(s) 408, the SaaS application(s) 410, and the identity provider 412 may be located within an on-premises data center of an organization for which the system 400 is deployed, within one or more cloud computing environments, or elsewhere.

FIG. 4B is a block diagram showing an example implementation of the system 400 shown in FIG. 4A in which various resource management services 402 as well as a gateway service 408 are located within a cloud computing environment 414. The cloud computing environment may, for example, include Microsoft Azure Cloud, Amazon Web Services, Google Cloud, or IBM Cloud.

For any of illustrated components (other than the client 202) that are not based within the cloud computing environment 414, cloud connectors (not shown in FIG. 4B) may be used to interface those components with the cloud computing environment 414. Such cloud connectors may, for example, run on Windows Server instances hosted in resource locations and may create a reverse proxy to route traffic between the site(s) and the cloud computing environment 414. In the illustrated example, the cloud-based resource management services 402 include a client interface service 416, an identity service 418, a resource feed service 420, and a single sign-on service 422. As shown, in some embodiments, the client 202 may use a resource access application 424 to communicate with the client interface service 416 as well as to present a user interface on the client 202 that a user 426 can operate to access the resource feed(s) 406 and/or the SaaS application(s) 410. The resource access application 424 may either be installed on the client 202, or may be executed by the client interface service 416 (or elsewhere in the system 400) and accessed using a web browser (not shown in FIG. 4B) on the client 202.

As explained in more detail below, in some embodiments, the resource access application 424 and associated components may provide the user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 424 is launched or otherwise accessed by the user 426, the client interface service 416 may send a sign-on request to the identity service 418. In some embodiments, the identity provider 412 may be located on the premises of the organization for which the system 400 is deployed. The identity provider 412 may, for example, correspond to an on-premises Windows Active Directory. In such embodiments, the identity provider 412 may be connected to the cloud-based identity service 418 using a cloud connector (not shown in FIG. 4B), as described above. Upon receiving a sign-on request, the identity service 418 may cause the resource access application 424 (via the client interface service 416) to prompt the user 426 for the user's authentication credentials (e.g., user-name and password). Upon receiving the user's authentication credentials, the client interface service 416 may pass the credentials along to the identity service 418, and the identity service 418 may, in turn, forward them to the identity provider 412 for authentication, for example, by comparing them against an Active Directory domain. Once the identity service 418 receives confirmation from the identity provider 412 that the user's identity has been properly authenticated, the client interface service 416 may send a request to the resource feed service 420 for a list of subscribed resources for the user 426.

In other embodiments (not illustrated in FIG. 4B), the identity provider 412 may be a cloud-based identity service, such as a Microsoft Azure Active Directory. In such embodiments, upon receiving a sign-on request from the client interface service 416, the identity service 418 may, via the client interface service 416, cause the client 202 to be redirected to the cloud-based identity service to complete an authentication process. The cloud-based identity service may then cause the client 202 to prompt the user 426 to enter the user's authentication credentials. Upon determining the user's identity has been properly authenticated, the cloud-based identity service may send a message to the resource access application 424 indicating the authentication attempt was successful, and the resource access application 424 may then inform the client interface service 416 of the successfully authentication. Once the identity service 418 receives confirmation from the client interface service 416 that the user's identity has been properly authenticated, the client interface service 416 may send a request to the resource feed service 420 for a list of subscribed resources for the user 426.

For each configured resource feed, the resource feed service 420 may request an identity token from the single sign-on service 422. The resource feed service 420 may then pass the feed-specific identity tokens it receives to the points of authentication for the respective resource feeds 406. Each resource feed 406 may then respond with a list of resources configured for the respective identity. The resource feed service 420 may then aggregate all items from the different feeds and forward them to the client interface service 416, which may cause the resource access application 424 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 410 to which the user 426 has subscribed. The lists of local applications and the SaaS applications 410 may, for example, be supplied by resource feeds 406 for respective services that manage which such applications are to be made available to the user 426 via the resource access application 424. Examples of SaaS applications 410 that may be managed and accessed as described herein include Microsoft Office 365 applications, SAP SaaS applications, Workday applications, etc.

For resources other than local applications and the SaaS application(s) 410, upon the user 426 selecting one of the listed available resources, the resource access application 424 may cause the client interface service 416 to forward a request for the specified resource to the resource feed service 420. In response to receiving such a request, the resource feed service 420 may request an identity token for the corresponding feed from the single sign-on service 422. The resource feed service 420 may then pass the identity token received from the single sign-on service 422 to the client interface service 416 where a launch ticket for the resource may be generated and sent to the resource access application 424. Upon receiving the launch ticket, the resource access application 424 may initiate a secure session to the gateway service 408 and present the launch ticket. When the gateway service 408 is presented with the launch ticket, it may initiate a secure session to the appropriate resource feed and present the identity token to that feed to seamlessly authenticate the user 426. Once the session initializes, the client 202 may proceed to access the selected resource.

When the user 426 selects a local application, the resource access application 424 may cause the selected local application to launch on the client 202. When the user 426 selects a SaaS application 410, the resource access application 424 may cause the client interface service 416 request a one-time uniform resource locator (URL) from the gateway service 408 as well a preferred browser for use in accessing the SaaS application 410. After the gateway service 408 returns the one-time URL and identifies the preferred browser, the client interface service 416 may pass that information along to the resource access application 424. The client 202 may then launch the identified browser and initiate a connection to the gateway service 408. The gateway service 408 may then request an assertion from the single sign-on service 422. Upon receiving the assertion, the gateway service 408 may cause the identified browser on the client 202 to be redirected to the logon page for identified SaaS application 410 and present the assertion. The SaaS may then contact the gateway service 408 to validate the assertion and authenticate the user 426. Once the user has been authenticated, communication may occur directly between the identified browser and the selected SaaS application 410, thus allowing the user 426 to use the client 202 to access the selected SaaS application 410.

In some embodiments, the preferred browser identified by the gateway service 408 may be a specialized browser embedded in the resource access application 424 (when the resource application is installed on the client 202) or provided by one of the resource feeds 406 (when the resource application 424 is located remotely), e.g., via a secure browser service. In such embodiments, the SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have the client interface service 416 send the link to a secure browser service, which may start a new virtual browser session with the client 202, and thus allow the user to access the potentially harmful linked content in a safe environment.

In some embodiments, in addition to or in lieu of providing the user 426 with a list of resources that are available to be accessed individually, as described above, the user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for a client 202. In the example shown, in addition to the client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 424 without having to launch the native application. The system shown in FIG. 4C may, for example, aggregate relevant notifications, tasks, and insights, and thereby give the user 426 a dynamic productivity tool. In some embodiments, the resource activity feed may be intelligently populated by utilizing machine learning and artificial intelligence (AI) algorithms. Further, in some implementations, microapps may be configured within the cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, the systems of record 428 may represent the applications and/or other resources the resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 402, and in particular the data integration provider service 432, may, for example, support REST API, JSON, OData-JSON, and 6ML. As explained in more detail below, the data integration provider service 432 may also write back to the systems of record, for example, using OAuth2 or a service account.

In some embodiments, the microapp service 430 may be a single-tenant service responsible for creating the microapps. The microapp service 430 may send raw events, pulled from the systems of record 428, to the analytics service 438 for processing. The microapp service may, for example, periodically pull active data from the systems of record 428.

In some embodiments, the active data cache service 436 may be single-tenant and may store all configuration information and microapp data. It may, for example, utilize a per-tenant database encryption key and per-tenant database credentials.

In some embodiments, the credential wallet service 434 may store encrypted service credentials for the systems of record 428 and user OAuth2 tokens.

In some embodiments, the data integration provider service 432 may interact with the systems of record 428 to decrypt end-user credentials and write back actions to the systems of record 428 under the identity of the end-user. The write-back actions may, for example, utilize a user's actual account to ensure all actions performed are compliant with data policies of the application or other resource being interacted with.

In some embodiments, the analytics service 438 may process the raw events received from the microapps service 430 to create targeted scored notifications and send such notifications to the notification service 440.

Finally, in some embodiments, the notification service 440 may process any notifications it receives from the analytics service 438. In some implementations, the notification service 440 may store the notifications in a database to be later served in a notification feed. In other embodiments, the notification service 440 may additionally or alternatively send the notifications out immediately to the client 202 as a push notification to the user 426.

In some embodiments, a process for synchronizing with the systems of record 428 and generating notifications may operate as follows. The microapp service 430 may retrieve encrypted service account credentials for the systems of record 428 from the credential wallet service 434 and request a sync with the data integration provider service 432. The data integration provider service 432 may then decrypt the service account credentials and use those credentials to retrieve data from the systems of record 428. The data integration provider service 432 may then stream the retrieved data to the microapp service 430. The microapp service 430 may store the received systems of record data in the active data cache service 436 and also send raw events to the analytics service 438. The analytics service 438 may create targeted scored notifications and send such notifications to the notification service 440. The notification service 440 may store the notifications in a database to be later served in a notification feed and/or may send the notifications out immediately to the client 202 as a push notification to the user 426.

In some embodiments, a process for processing a user-initiated action via a microapp may operate as follows. The client 202 may receive data from the microapp service 430 (via the client interface service 416) to render information corresponding to the microapp. The microapp service 430 may receive data from the active data cache service 436 to support that rendering. The user 426 may invoke an action from the microapp, causing the resource access application 424 to send that action to the microapp service 430 (via the client interface service 416). The microapp service 430 may then retrieve from the credential wallet service 434 an encrypted Oauth2 token for the system of record for which the action is to be invoked, and may send the action to the data integration provider service 432 together with the encrypted Oath2 token. The data integration provider service 432 may then decrypt the Oath2 token and write the action to the appropriate system of record under the identity of the user 426. The data integration provider service 432 may then read back changed data from the written-to system of record and send that changed data to the microapp service 430. The microapp service 430 may then update the active data cache service 436 with the updated data and cause a message to be sent to the resource access application 424 (via the client interface service 416) notifying the user 426 that the action was successfully completed.

In some embodiments, in addition to or in lieu of the functionality described above, the resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 402 may, for example, parse these requests and respond because they are integrated with multiple systems on the back-end. In some embodiments, users may be able to interact with the virtual assistance through either the resource access application 424 or directly from another resource, such as Microsoft Teams. This feature may allow employees to work efficiently, stay organized, and deliver only the specific information they are looking for.

### E. Systems and Methods for Providing File Sharing Over Network(s)

As FIG. 5 illustrates, in some embodiments, a file sharing system 510 may include an access management system 512 and a storage system 514. In some embodiments, the file sharing system 510 may be distributed between two sub-systems, with one subsystem (e.g., the access management system 512) being responsible for controlling access to files stored in the other subsystem (e.g., the storage system 514). FIG. 5 illustrates conceptually how one or more clients 202 may interact with two such subsystems.

The access management system 512 may include one or more servers and a database, and the storage system 514 may include one or more storage control servers and a storage medium. In some embodiments, the access management server(s) may, for example, allow a user of the client 202 to log in to his or her account, e.g., by entering a user name and password corresponding to account data stored in the access management database. Once the user of the client 202 has logged in, the access management system 512 may enable the user to view (via the client 202) information identifying various folders represented in the storage system 514, as well as any files contained within such folders. File/folder metadata stored in the access management database may be used to identify the files and folders in the storage system to which a particular user has been provided access rights.

The database associated with the access management system 512 may, for example, include information used to process user requests, such as user account data (e.g., username, password, access rights, security questions and answers, etc.), file and folder metadata (e.g., name, description, storage location, access rights, source IP address, etc.), and logs, among other things. In some embodiments, the database at the access management system 512 may store an image, such as a profile image, identifying or representing the user (e.g., a photo of the user). As described herein, the profile image may be used by the physical access management system 102 to determine if the person(s) detected around the user are authorized to access the file the user is accessing via client 202.

As shown in FIG. 5, an authorized user operating a client 202, which may take on any of numerous forms, may log in to the access management system 512, for example, by entering a valid user name and password. In some embodiments, the access management system 512 may include one or more webservers that respond to requests from the client 202. The access management system 512 may store metadata concerning the identity and arrangements of files stored by the storage system 514, such as folders maintained by the storage system 514 and any files contained within such folders. In some embodiments, the metadata may also include permission metadata identifying the folders and files each user is allowed to access. The permission metadata may also indicate if the file is confidential, secure or otherwise contains information that should be accessed in a restricted manner. As described herein, the permission metadata may be used by the physical access management system 102 to determine which persons/users are authorized to access a file. The permission metadata may also be used by the physical access management system 102 to determine a threat level assigned to the file by an administrator, a creator of the file, or another user who has authority to restrict access to the file. Once logged in, the user may employ a user-interface mechanism of the client 202 to navigate among folders for which the metadata indicates the user has access permission.

In some embodiments, the logged-in user may select a particular file the user wants to access and/or to which the logged-in user wants a different user of a different client 202 to be able to access. Upon receiving such a selection from a client 202, the access management system 512 may take steps to authorize access to the selected file 228 by the logged-in client 202 and/or the different client 202. In some embodiments, for example, the access management system 512 may interact with the storage system 514 to obtain a unique “download” token which may subsequently be used by a client 202 to retrieve the identified file 228 from the storage system 514. The access management system 512 may, for example, send the download token to the logged-in client 202 and/or a client 202 operated by a different user. In some embodiments, the download token may a single-use token that expires after its first use.

In some embodiments, a logged-in user may select a folder on the file sharing system to which the user wants to transfer one or more files from the logged-in client 202, or to which the logged-in user wants to allow a different user of a different client 202 to transfer one or more files. Additionally or alternatively, the logged-in user may identify one or more different users (e.g., by entering their email addresses) the logged-in user wants to be able to access one or more files currently accessible to the logged-in client 202.

Similar to the file downloading process described above, upon receiving such a selection from a client 202, the access management system 512 may take steps to authorize access to the selected folder by the logged-in client 202 and/or the different client 202. In some embodiments, for example, the access management system 512 may interact with the storage system 514 to obtain a unique “upload token” which may subsequently be used by a client 202 to transfer one or more files from the client 202 to the storage system 514. The access management system 512 may, for example, send the upload token to the logged-in client 202 and/or a client 202 operated by a different user.

One or more files may be transferred from a client 202 to the storage system 514 in response to a request that includes the upload token. In some embodiments, for example, the upload token may be appended to a URL that resolves to an IP address of the webserver(s) of the storage system 514. For example, in some embodiments, in response to a logged-in user selecting a folder to which the user desires to transfer one or more files and/or identifying one or more intended recipients of such files, the access management system 512 may return a webpage requesting that the user drag-and-drop or otherwise identify the file(s) 228 the user desires to transfer to the selected folder and/or a designated recipient. The returned webpage may also include an “upload link,” e.g., in the form of an “UPLOAD” button or other user-interface element that the user can select to effect the transfer of the file(s) from the client 202 to the storage system 514.

### F. Detailed Description of Example Embodiments of a Physical Access Management System for File Contents

The present disclosure describes a system to detect persons who might be able to access contents of a file while the user is accessing them via a device. In some embodiments, the system may analyze an image captured by the device to determine whether there are persons, other than the user, close enough to the device to be able to access the file contents. Based on the type of file contents, the system may determine a threshold distance within which persons are likely able to view, read, listen to, or otherwise have physical access to the file contents. If one or more persons are within the threshold distance of the device, then the system may warn the user, e.g., by outputting an indication and/or by modifying the output of the file contents, that other persons might be able to view, read, listen to, or otherwise physically access the file contents. In some embodiments, the system may determine whether the persons other than the user are authorized to access the file contents, and may not warn the user in that case.

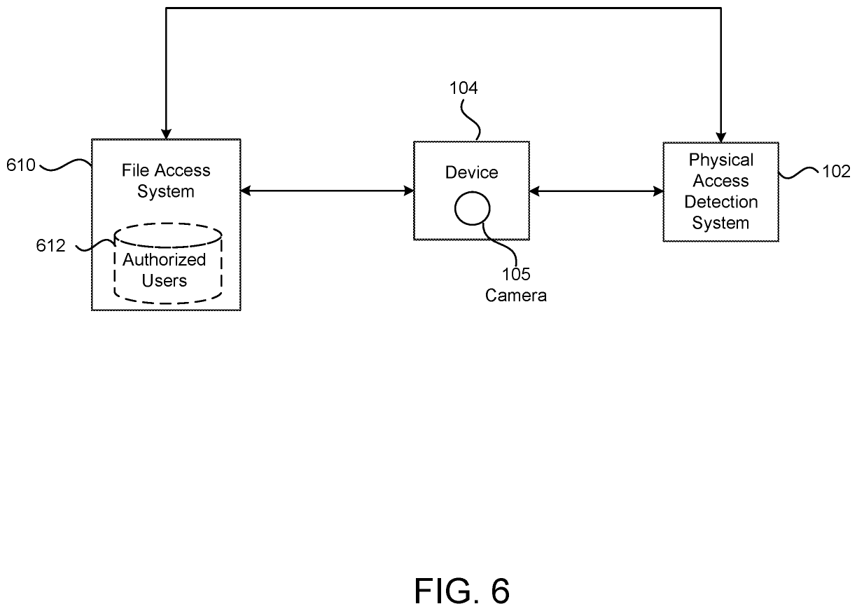

FIG. 6 is a diagram illustrating an example use of a physical access management system in accordance with some embodiments. The physical access management system 102 may be implemented, in whole or in part, either remotely, e.g., by one or more servers, or at the device 104. In some embodiments, one or more components of the device 104 may communicate with one or more components of the physical access management system 102, such as via one or more networks 206 of type described above. For example, the camera 105 of the device 104 may send images to the physical access management system 102 for analysis. In some embodiments, the device 104 may also be in communication with a file access system 610 (e.g., the file sharing system 510 described above). The file access system 610 may include files that can be accessed by various users as well as metadata associated with such files. The metadata may indicate, for example, whether the file is tagged as confidential, secure, sensitive, or otherwise restricted for access only by authorized users. In some implementations, the metadata may also indicate one or more users that are authorized to access the file. As shown in FIG. 6, the file access system 610 may include a database 612 storing data relating to authorized users. The database 612 may include images of users who are authorized to download files from, upload files to, or otherwise access files via the file access system 610. The physical access management system 102 may be in communication with the file access system 610, e.g., via one or more of the networks 206 described above, to retrieve information on users authorized to access a particular file and to retrieve images of the authorized users. In some embodiments, the physical access management system 102 may be implemented as part of the file access system 610.

FIG. 7 is a diagram illustrating components of an example of a physical access management system 102 in accordance with some embodiments the present disclosure. As shown, a computing device/system 700 including one or more processor(s) 702 and memory 704 may implement components of the physical access management system 102. The computing device/system 700 may be a server (e.g., server 204) or a client device (e.g., client 202), and the physical access management system 102 may be an application (e.g., application 220/220′ of FIG. 2B) operated or executed by the computing device/system 700. As FIG. 7 illustrates, the physical access management system 102 may include a person detection component 710, a distance threshold component 720, an authorized user component 730, a location component 740, an output generation component 750, and a threat level component 760. Although FIG. 7 shows particular components, it should be understood that the physical access management system 102 may be configured with fewer or more components to perform the functionalities described below.

The person detection component 710 may be configured to analyze images captured by the device 104 to determine whether such images include persons other than the user 106. The person detection component 710 may use one or more techniques, such as image analysis, object detection processing, facial detection s, facial recognition, computer vision, etc., to identify persons other than the user 106. If no persons other than the user 106 are detected, then the person detection component 710 may not send any data to the other components of the physical access management system 102. If a person other than the user 106 is detected, however, then the person detection component 710 may send data to the other components of the physical access management system 102 to initiate further analysis. For example, the person detection component 710 may send the image captured by the camera 105 to the distance threshold component 720 and the authorized user component 730 for further analysis. The person detection component 710 may, for example, send a signal to the location component 760 to initiate its processing in response to detecting other persons near the device 104. The person detection component 710 may also be configured to determine the number of persons detected in the image other than the user 106.

The person detection component 710 may analyze an image of the user 106 to help determine that there are persons in the image who are not the user 106. The person detection component 710 may retrieve the image of the user 106 from the device 104 or from a database storing images of users who have authorized the physical access management system 102 to perform the functionalities described herein, e.g., employees of the same organization as the user. The person detection component 710 may compare the retrieved image of the user 106 with the image captured by the device 104 at the time the file is being accessed to determine if persons other than the user 106 are represented in the captured image.

The person detection component 710 may also be configured to detect that contents of a file are being presented to the user 106 via the device 104. The contents of the file may be presented to the user 106 by the device 104, for example, when the device 104 displays visual information represented by the file and/or by plays audio represented by the file. The contents may be displayed via a screen of the device 104, such as by displaying text, images, videos, etc., and/or by outputting audio via speakers of the device 104. The person detection component 710 may monitor the device 104 for such activity with respect to the file.

In some embodiments, the person detection component 710 may also determine whether the file is restricted with respect to whom may access it, e.g., using metadata associated with the file. For example, the file may be tagged as confidential, secure, sensitive, private or otherwise restricted to access by authorized users. In response to this detection, the person detection component 710 may analyze the image captured by the camera 105 to determine if persons other than the user 106 are able to access/view/listen to the file contents being presented to the user 106.

The distance threshold component 720 may be configured to determine whether the other persons detected by the person detection component 710 are close enough to the device 104 that they are likely able to view, read, listen to, or otherwise physically access to the file contents. The distance threshold component 720 may be configured to analyze the images captured by the camera 105 to determine a distance between the persons (other than the user 106) and the device 104. The distance threshold component 720 may use various processes, including but not limited to, image analysis, computer vision techniques, object detection processing, and others, to determine the distance between the persons and the device 104. The distance threshold component 720 may also be configured to determine a threshold distance within which the other persons might be able to physically access (e.g., view or listen to) the file contents. In some embodiments, the distance threshold component 720 may determine the threshold distance based on the type of file contents, the manner in which such contents are presented to the user 106, the type of device 104, and/or the display screen size of the device 104. For example, if the file content being presented to the user 106 is text, then the distance threshold component 720 may determine the threshold distance based on the size of the text being displayed, where the threshold distance may be greater (e.g., two meters) when the font size is larger (e.g., larger than 12 point), and the threshold distance may be smaller (e.g., one meters) when the font size is smaller (e.g., smaller than twelve point). In another example, if the file content being presented to the user 106 is audio using the speakers of the device 104, then the distance threshold component 720 may determine the threshold distance based on the output volume of the speakers, where the threshold distance may be greater when the volume is louder. In another example, distance threshold component 720 may determine the threshold distance to be greater when the screen size of the device 104 is larger (e.g., a thirteen inch screen) as compared to the threshold distance for when the screen size of the device 104 is smaller (e.g., an eight inch screen).

In other embodiments, the distance threshold component 720 may determine the threshold distance based on other information related to the file, the user 106, the location of the device 104, and the like. For example, the threshold distance may depend on whether the user 106 is accessing the file in a crowded public space or a private space. In another example, the threshold distance may be based on criteria defined with respect to the file by the creator of the file or the person sharing the file with the user, where the criteria may indicate the threshold distance is to be based on where the device 104 is located when presenting the file contents (e.g., at work, at home, or in a public place like a train station).

The distance threshold component 720 may be configured to compare the determined threshold distance and the distance between the other persons and the device 104 to determine whether another person is within the threshold distance and thus likely able to physically access to the file contents. The distance threshold component 720 may perform this determination for individual persons detected in the image. For example, if three other persons were detected in the image, then the distance threshold component 720 may determine a distance between the three persons and the device 104, and determine if any of them, and which one of them, is within the threshold distance. If any of the other persons are within the threshold distance, the distance threshold component 720 may send data and/or a signal to one or more of the other components of the physical access management system 102. For example, the distance threshold component 720 may send information to the authorized user component 730 to initiate a check for persons authorized to access the file.

The authorized user component 730 may be configured to determine whether a person detected near the device 104 is authorized to access the file whose contents are being output by the device to the user 106. In some implementations, the authorized user component 730 may determine the number of users authorized to access the file using metadata associated with the file. If the number of authorized users is one, for example, then the authorized user component 730 may not continue the analysis and/or send a signal to the output generation component 750 to initiate generation of a warning and/or modification of the output of the file contents. If the number of authorized users able to access the file is more than one, on the other hand, then the authorized user component 730 may retrieve images of the authorized users from a database (e.g., database 612). The authorized user component 730 may compare the images of the authorized users and the image captured by the camera 105 to determine if the person or persons detected near the device 104 are authorized to access the file. The authorization user component 730 may perform the determination using facial recognition techniques, facial matching processing, or the like.

The location component 740 may be configured to determine a current location of the device 104 and/or the user 106 using the device 104. The location component 740 may, for example, use a location, e.g., a global positioning system (GPS) sensor, associated with the device 104 or other devices of the user 106 to determine the location of the user 106. The location component 740 may, for example, determine whether the user 106 is located in a public area (e.g., train station, coffee shop, etc.) or in a private area (e.g., home or work) by determining the GPS location of the device 104. For example, using the GPS location of the device 104 the location component 740 may determine if the location is a home, an office building, a coffee shop, a train station, etc. In some embodiments, the location component 740 may send the determined location information to the distance threshold component 720 to help determine the threshold distance. In other embodiments, the physical access management system 102 may use the location information determined by the location component 740 to determine whether steps should be performed to detect persons near the device 104. For example, in some embodiments to conserve resources, the physical access management system 102 may not perform steps to detect other persons near the device 104 if the user 106 is in a private area, such as within an office space of the user's employer.

In some embodiments, the output generation component 750 may be configured to generate an output based on the determination by the distance threshold component 720 that one or more persons, other than the user 106, are close enough to the device 104 and are likely able to physically access the file contents. The output generation component 750 may, for example, generate a warning, a message (visual or audio), a dialog box, or other indication informing the user 106 that other persons might be able to access the file contents. The output generation component 750 may cause the device 104 to output the indication. In some embodiments, the output generation component 750 may generate the indication based on the type of file contents being accessed. For example, if the contents are being displayed, then the output generation component 750 may generate a visual indication, and if the contents are being outputted using speakers, then the output generation component 750 may generate an audio indication.

In some embodiments, the output generation component 750 may additionally or alternatively be configured to modify the output of the file contents. The output generation component 750 may perform such modification based on the type of file contents being accessed. For example, if the contents are being displayed, the output generation component 750 may cause the device 104 to blur or obscure its display screen so as to render the contents unreadable or un-viewable. Additionally or alternatively, the output generation component 750 may cause the device 104 to shrink or minimize the window displaying the contents and/or send the window to the background behind other application windows. If the contents are being outputted using speakers, then the output generation component 750 may stop the audio playback or lower the volume of the speakers so that other persons cannot hear the contents anymore.

In some embodiments, the threat level component 760 may be configured to compute a threat value based on various factors, including but not limited to, the distance between the other persons and the device 104, the location of the device 104, the readability or accessibility of the file contents, and the number of other persons near the device 104. The threat level component 760 may use the threat value to determine whether or not the file contents can be securely presented to the user 104. The threat value may be binned into a level of threat, for example, very low threat, low threat, moderate threat, high threat, and very high threat.

In some embodiments, the threat level may specify one or more configurable conditions. For example, a very low threat level may be defined by an administrator or file access system manager as (1) the user 106 is in a location identified as the user's work environment and (2) there are no other persons detected in the background. As another example, a moderate threat level may be when (1) the user 106 is in a location identified as the user's work environment and (2) there are some other persons detected in the background within a threshold distance of the device 104. In another example, a very high threat level may be defined as when (1) the user 106 is not at located at the user's work environment and (2) there are many persons detected in the background within a threshold distance of the device 104.

A user that shared the file with the user 106 or that controls access rights to the file (e.g., an administrator, an owner of the file, a creator of the file, etc.) may configure access settings for a file based on threat levels, thus, identifying the conditions under which the user 106 is able to access the file. The settings may be saved as metadata associated with the file. For example, an administrator user may configure settings for a file indicating that if the threat level is very low then the user 106 is allowed access to the file contents; if the threat level is moderate then the user 106 is allowed access to the file contents with a pop-up notification informing the user of other persons being detected in the background; and if the threat level is very high then the user 106 is not allowed access to the file contents.

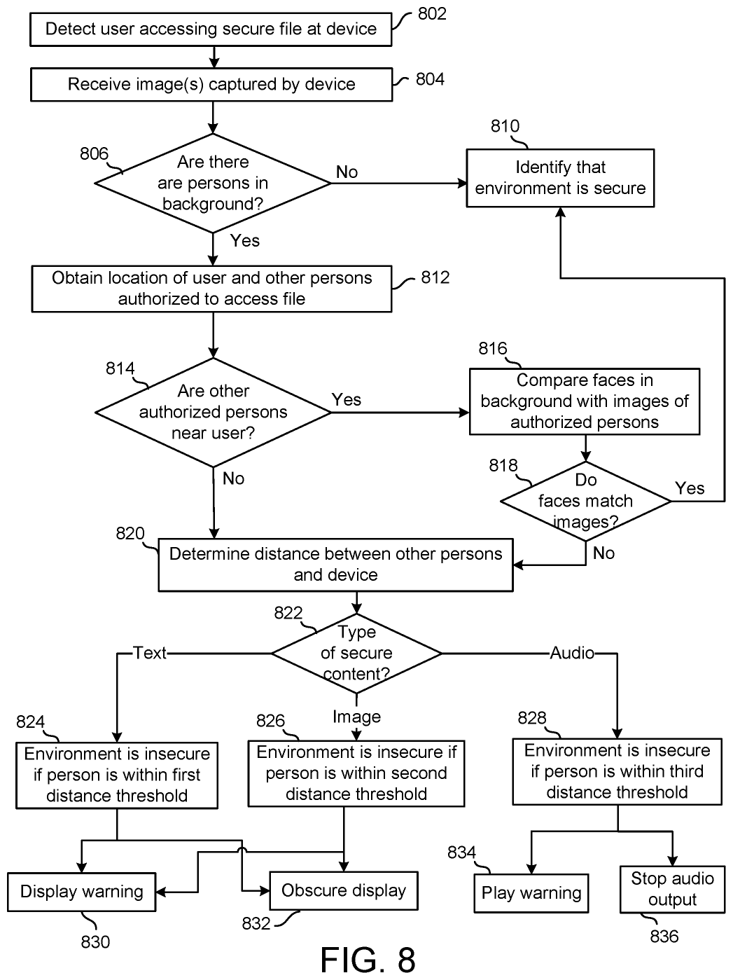

FIG. 8 illustrates a flowchart of an example process of protecting contents of a file in accordance with some embodiments. The process may, for example, be performed by one or more components of the physical access management system 102 described in relation to FIG. 7. In some embodiments, the described steps may be performed by one or more processors that are configured and arranged to execute instructions encoded on one or more computer-readable media.

The person detection component 710 may detect (802) the user 106 accessing a secure file at the device 104, in response to which the person detection component 710 may receive (804) image(s) captured by the device 104 using an image capture device. The person detection component 710 may determine (806) whether there are persons in the background other than the user (that is, whether there are persons other than the user near or in an area around the device 104). The person detection component 710 may make this determination using the images received in step 804. If there are no other persons detected in the background, the person detection component 710 may identify (810) the user's environment as secure and allow the user 106 to access the contents of the secure file.

If there are other persons detected in the background, then the location component 740, in some embodiments, may obtain (812) the location of the user 106 and the location of one or more persons (other than the user) authorized to access the file. In some embodiments, the location component 740 may determine (814) whether any of the persons authorized to access the file are near the user 106 accessing the file. If yes, then the authorized user component 730 may compare (816) the faces of the persons in the background (from the received image(s) in step 804) with images of the authorized persons. In no, then the process may proceed to step 820. The physical access management system 102 may determine which persons are authorized to access the file by retrieving metadata associated with the file, and may retrieve images of the authorized persons from a system database.

In some embodiments, the steps 812 and 814 are not performed, and after the person detection component 710 performs the step 806 and determines that there are other persons in the background, then the authorized user component 730 may performs step 816 and compare the faces in the background with images of the authorized persons.

The authorized user component 730 may determine (818) whether the faces in the background match the images of the authorized persons. If yes, then the authorized user component 730 may identify (810) the user's environment as secure and allow the user 106 to access the contents of the secure file. If no, then the process may proceed to step 820.

The distance threshold component 720 may determine (820) a distance between the other persons in the background and the device 104, and may then determine (822) the type of secure content of the file. If the content includes text, then the distance threshold component 720 may determine (824) that the user's environment is insecure if one or more of the other unauthorized persons is within a first distance threshold. If the content includes one or more images, then the distance threshold component 720 may determine (826) that the user's environment is insecure if one or more of the other persons is within a second distance threshold. If the content includes audio, then the distance threshold component 720 may determine (828) that the user's environment is insecure if one or more of the other persons is within a third distance threshold. In some implementations, the distance threshold component 720 may identify a distance threshold based on the type of content being presented to the user 106. In some embodiments, the distance threshold component 720 may additionally or alternatively identify a distance threshold based on accessibility of the file content, where the accessibility may depend, for example, on the type of device 104, the screen size of the device 104, the volume of the audio being output by speakers of the device 104, the font size and/or image size being presented to the user 106, and the like.

After steps 824 and 826, the process may proceed to one or both of steps 830 and 832. After step 834, the process may proceed to one or both of steps 834 and 836. The output generation component 750 may generate and display (830) a warning via the device 104 informing the user 106 that other persons in the background may be able to view the file contents. The output generation component 750 may also obscure (832) the display component of the device 104 so that the other persons in the background are unable to view the file contents. The output generation component 750 may generate and play (834) an audio warning via the speakers of the device 104 to inform the user 106 that other persons in the background may be able to listen to the file contents. The output generation component 750 may also stop (836) outputting the audio at the device 104 so that other persons in the background are unable to listen to the file contents.

In this manner, the present disclosure describes a system that can receive image data from a client device in response to a request to access a file, determine that the image data indicates at least one other person near the client device in addition to a user accessing the file, and cause the client device to modify an output of the file to prevent receipt of the file content by the other person. In some embodiments, the output of the file may be modified in response to determining that the other person is within a threshold distance of the computing device, where the threshold distance is determined based on the accessibility of the content of the file. In other embodiments, the output of the file may be modified in response to determining that the other person is unauthorized to access the file.

G. Example Implementations of Methods, Systems, and Computer-Readable Media in Accordance with the Present Disclosure

The following paragraphs (M1) through (M13) describe examples of methods that may be implemented in accordance with the present disclosure.

(M1) A computing system or a computing device may perform a method that involves receiving an input indicative of at least one person proximate to the computing device, the at least one person being different than a user of the computing device, determining that the at least one person is within a threshold distance from the computing device based on the received input, and modifying an output of the computing device in response to the determination of the at least one person being within the threshold distance from the computing device, so as to inhibit receipt of content from the computing device by the at least one person.

(M2) A method may be performed as described in paragraph (M1), further involves determining that the content includes text, determining a font size of the text being presented by a display component of the computing device, and determining the threshold distance based at least in part on the font size.

(M3) A method may be performed as described in paragraph (M1) or (M2), further involves determining that the content includes an image, determining a size of the image being presented by a display component of the computing device, and determining the threshold distance based at least in part on the size of the image.

(M4) A method may be performed as described in any of paragraphs (M1) through (M3), wherein the received input from the computing device includes data from an image capture device of the computing device, and the method may further comprise determining one or more authorized persons to access the content, retrieving images of the authorized persons, processing the images of the authorized persons and the received data from the image capture device to determine that the at least one other person represented in the received data is unauthorized to access the file, and causing the computing device to output an indication informing the user of the at least one other person capable of accessing the content in response to the determination that the at least one person is unauthorized to access the file and the determination of the at least one person being within the threshold distance of the computing device.

(M5) A method may be performed as described in any of paragraphs (M1) through (M4), and may further comprise identifying that the computing device is located within a geographic area associated with a work environment of the user, and determining the authorized persons to access the content in response to identifying that the computing device is located within the geographic area.

(M6) A method may be performed as described in any of paragraphs (M1) through (M5), and may further comprise receiving a user input from the computing device in response to the computing device modifying the output of the computing device, where the user input is indicative approval from the user to continue outputting the content, and receiving additional input from the computing device indicative of at least one additional person proximate to the computing device. The method may also involve determining that the at least one additional person is within the threshold distance of the computing device, determining authorized persons to access the content, processing images of the authorized persons and the received additional input to determine that the at least one additional person is authorized to access the content, and causing the computing device to continue outputting the content based at least in part on the at least one additional person being authorized to access the content.

(M7) A method may be performed as described in any of paragraphs (M1) through (M6) and may further comprise detecting that the content is designated as secure, and receiving the input from the computing device based at least in part on the detection of the content being designated as secure.

(M8) A method may be performed as described in any of paragraphs (M1) through (M7), and may further comprise determining that the content includes audio, determining an output volume being used to output the audio via at least one speaker of the computing device, and determining the threshold distance based at least in part on the output volume.

(M9) A method may be performed as described in any of paragraphs (M1) through (M8), and may further comprise causing the computing device to output an audio warning using the speaker of the computing device, the audio warning informing the user that the at least one person proximate to the computing device is capable of receiving the audio.

(M10) A computing system or a computing device may perform a method that involves receiving data via an image capture device of a computing device in response to a request to access a file, where the data indicative of at least one person proximate to the computing device, the at least one person being in addition to a user of the computing device, and determining at least one authorized person in addition to the user, the at least one authorized person authorized to access the file. The method also further involves receiving an image of the at least one authorized person, processing the received data from the image capture device of the computing device and the image of the at least one authorized person to determine that the at least one person is unauthorized to access the file, and modifying an output of the computing device in response to the determination that the at least one person is unauthorized to access the file, so as to inhibit receipt of the file by the at least one person.

(M11) A method may be performed as described in paragraph (M10), and may further comprise receiving an input from the computing device in response to modifying the output of the computing device, where the input is indicative of an approval from the user to continue outputting the content of the file, and receiving additional data via the image capture device of the computing device, where the additional data indicative of at least one additional person proximate to the computing device in addition to the user, the additional data being captured after receiving the input. The method further involves processing the received additional data from the image capture device of the computing device and the image of the at least one authorized person to determine that the at least one additional person is authorized to access the file, and causing the computing device to continue outputting the file in response to the determination that the at least one additional other person is authorized to access the file.

(M12) A method may be performed as described in paragraph (M10) or (M11), and may further comprise determining, using the received data from the image capture device, a distance of the at least one person from the computing device, determining that the distance of the at least one person is within a threshold distance from the computing device, and wherein processing the received data from the image capture device and the image of the at least one authorized person is performed in response to the determination that the at least one person is within the threshold distance from the computing device.

(M13) A method may be performed as described in any of paragraphs (M10) through (M12), and may further comprise identifying that the computing device is located within a geographic area associated with a work environment of the user, and determining the at least one authorized person to access the file in response to identifying that the computing device is located within the geographic area.

(M14) A method may be performed as described in any of paragraphs (M10) through (M13), and may further comprise determining accessibility of the file based on the manner of output of the file, and determining a threshold distance from the computing device based on the accessibility of the file, where the threshold distance is indicative of a distance within which the at least one person is capable of receiving contents of the file.

(M15) A method may be performed as described in any of paragraphs (M10) through (M14), and may further comprise determining that the file includes text and an image, determining the accessibility of the file based on a font size of the text being presented by a display component of the computing device and a size of the image being presented by a display component of the computing device, and modifying the output of the computing device by outputting a message using the display component of the computing device in response to the determination that the at least one person is within the threshold distance from the computing device, where the message informs the user that the at least one person is capable of accessing contents of the file.

(M16) A method may be performed as described in any of paragraphs (M10) through (M14), and may further comprise determining that the file includes audio, determining the accessibility of the file based on the audio being outputted using a speaker of the computer device and an output volume being used to output the audio, and causing the computer device to output an audio warning using the speaker of the computing device in response to the determination that the at least one person is within the threshold distance from the computing device, where the audio warning informs the user that the at least one person proximate to the computing device is capable of receiving the audio.

(M17) A method may be performed as described in any of paragraphs (M10) through (M16), and may further comprise detecting that the file is designated as secure, and receiving the data from the image capture device in response to the detection that the file is designated as secure.

The following paragraphs (S1) through (S17) describe examples of systems that may be implemented in accordance with the present disclosure.

(S1) A system may comprise at least one processor and at least one computer-readable medium encoded with instructions which, when executed by the at least one processor, may cause the system to receive an input indicative of at least one person proximate to the computing device, the at least one person being different than a user of the computing device, determine that the at least one person is within a threshold distance from the computing device based on the received input, and modify an output of the computing device in response to the determination of the at least one person being within the threshold distance from the computing device, so as to inhibit receipt of content from the computing device by the at least one person.

(S2) A system may be configured as described in paragraph (S1), wherein the computer-readable medium is encoded with additional instructions which, when executed by the at least one processor, may further cause the system to determine that the content includes text, determine a font size of the text being presented by a display component of the computing device, and determine the threshold distance based at least in part on the font size.

(S3) A system may be configured as described in paragraph (S1) or (S2), wherein the computer-readable medium is encoded with additional instructions which, when executed by the at least one processor, may further cause the system to determine that the content includes an image, determine a size of the image being presented by a display component of the computing device, and determine the threshold distance based at least in part on the size of the image.

(S4) A system may be configured as described in any of paragraphs (S1) through (S3), wherein the received input from the computing device includes data from an image capture device of the computing device, and wherein the computer-readable medium is encoded with additional instructions which, when executed by the at least one processor, may further cause the system to determine one or more authorized persons to access the content, retrieve images of the authorized persons, process the images of the authorized persons and the received data from the image capture device to determine that the at least one other person represented in the received data is unauthorized to access the file, and cause the computing device to output an indication informing the user of the at least one other person capable of accessing the content of the file in response to the determination that the at least one person is unauthorized to access the file and the determination of the at least one person being within the threshold distance of the computing device.

(S5) A system may be configured as described in any of paragraphs (S1) through (S4), wherein the computer-readable medium is encoded with additional instructions which, when executed by the at least one processor, may further cause the system to identify that the computing device is located within a geographic area associated with a work environment of the user, and determine the authorized persons to access the content in response to identifying that the computing device is located within the geographic area.

(S6) A system may be configured as described in any of paragraphs (S1) through (S5), wherein the computer-readable medium is encoded with additional instructions which, when executed by the at least one processor, may further cause the system to receive a user input from the computing device in response to the computing device modifying the output of the file, where the user input is indicative of an approval from the user to continue outputting the content of the file, receive additional input from the computing device indicative of at least one additional person proximate to the computing device, determine that the at least one additional person is within the threshold distance of the computing device, determine authorized persons to access the content, retrieve images of the authorized persons, process the images of the authorized persons and the received additional input to determine that the at least one additional person is authorized to access the content, and cause the computing device to continue outputting the content based at least in part on the at least one additional person being authorized to access the content.

(S7) A system may be configured as described in any of paragraphs (S1) through (S6), wherein the computer-readable medium is encoded with additional instructions which, when executed by the at least one processor, may further cause the system to detect that the content is designated as secure, and receive the data from the computing device based at least in part on the detection of the content being designated as secure.

(S8) A system may be configured as described in any of paragraphs (S1) through (S7), wherein the computer-readable medium is encoded with additional instructions which, when executed by the at least one processor, may further cause the system to determine that the content includes audio, determine an output volume being used to output the audio via at least one speaker of the computing device, and determine the threshold distance based at least in part on the output volume.

(S9) A system may be configured as described in any of paragraphs (S1) through (S8), wherein the computer-readable medium is encoded with additional instructions which, when executed by the at least one processor, may further cause the system to cause the computing device to output an audio warning using the speaker of the computing device, the audio warning informing the user that the at least one person proximate to the computing device is capable of receiving the audio.

(S10) A system may comprise at least one processor and at least one computer-readable medium encoded with instructions which, when executed by the at least one processor, may cause the system to receive data via an image capture device of a computing device in response to a request to access a file, where the data indicative of at least one person proximate to the computing device, the at least one person being in addition to a user of the computing device, determine at least one authorized person in addition to the user, the at least one authorized person authorized to access the file, receive an image of the at least one authorized person, process the received data from the image capture device of the computing device and the image of the at least one authorized person to determine that the at least one person is unauthorized to access the file, and modify an output of the computing device in response to the determination that the at least one person is unauthorized to access the file, so as to inhibit receipt of the file by the at least one person.

(S11) A system may be configured as described in paragraph (S10), wherein the computer-readable medium is encoded with additional instructions which, when executed by the at least one processor, may further cause the system to receive an input from the computing device in response to modifying the output of the computing device, where the input is indicative of an approval from the user to continue outputting the content of the file, receive additional data via the image capture device of the computing device, where the additional data indicative of at least one additional person proximate to the computing device in addition to the user, the additional data being captured after receiving the input, process the received additional data from the image capture device of the computing device and the image of the at least one authorized person to determine that the at least one additional person is authorized to access the file, and cause the computing device to continue outputting the file in response to the determination that the at least one additional other person is authorized to access the file.

(S12) A system may be configured as described in any of paragraphs (S10) or (S11), wherein the computer-readable medium is encoded with additional instructions which, when executed by the at least one processor, may further cause the system to determine, using the received data from the image capture device, a distance of the at least one person from the computing device, determine that the distance of the at least one person is within a threshold distance from the computing device, and wherein processing the received data from the image capture device and the image of the at least one authorized person is performed in response to the determination that the at least one person is within the threshold distance from the computing device.

(S13) A system may be configured as described in any of paragraphs (S10) through (S12), wherein the computer-readable medium is encoded with additional instructions which, when executed by the at least one processor, may further cause the system to identify that the computing device is located within a geographic area associated with a work environment of the user, and determine the at least one authorized person to access the file in response to identifying that the computing device is located within the geographic area.

(S14) A system may be configured as described in any of paragraphs (S10) through (S13), wherein the computer-readable medium is encoded with additional instructions which, when executed by the at least one processor, may further cause the system to determine accessibility of the file based on the manner of output of the file, and determine a threshold distance from the computing device based on the accessibility of the file, where the threshold distance is indicative of a distance within which the at least one person is capable of receiving contents of the file.

(S15) A system may be configured as described in any of paragraphs (S10) through (S14), wherein the computer-readable medium is encoded with additional instructions which, when executed by the at least one processor, may further cause the system to determine that the file includes text and an image, determine the accessibility of the file based on a font size of the text being presented by a display component of the computing device and a size of the image being presented by a display component of the computing device, and modify the output of the computing device by outputting a message using the display component of the computing device in response to the determination that the at least one person is within the threshold distance from the computing device, where the message informs the user that the at least one person is capable of accessing contents of the file.

(S16) A system may be configured as described in any of paragraphs (S10) through (S14), wherein the computer-readable medium is encoded with additional instructions which, when executed by the at least one processor, may further cause the system to determine that the content of the file includes audio, determine the accessibility of the file based on the audio being outputted using a speaker of the computer device and an output volume being used to output the audio, and cause the computer device to output an audio warning using the speaker of the computing device in response to the determination that the at least one person is within the threshold distance from the computing device, where the audio warning informs the user that the at least one person proximate to the computing device is capable of receiving the audio.

(S17) A system may be configured as described in any of paragraphs (S10) through (S16), wherein the computer-readable medium is encoded with additional instructions which, when executed by the at least one processor, may further cause the system to detect that the file is designated as secure, and receive the data from the image capture device in response to the detection that the file is designated as secure.

The following paragraphs (CRM1) through (CRM17) describe examples of computer-readable media that may be implemented in accordance with the present disclosure.

(CRM1) At least one non-transitory, computer-readable medium may be encoded with instructions which, when executed by at least one processor included in a first computing system, cause the at least one processor to receive an input indicative of at least one person proximate to the computing device, the at least one person being different than a user of the computing device, determine that the at least one person is within a threshold distance from the computing device based on the received input, and modify an output of the computing device in response to the determination of the at least one person being within the threshold distance from the computing device, so as to inhibit receipt of content from the computing device by the at least one person.

(CRM2) At least one non-transitory, computer-readable medium may be encoded with instructions as described in paragraph (CRM1), and may be further encoded with additional instructions which, when executed by the at least one processor, may further cause the at least one processor to determine that the content includes text, determine a font size of the text being presented by a display component of the computing device, and determine the threshold distance based at least in part on the font size.

(CRM3) At least one non-transitory, computer-readable medium may be encoded with instructions as described in paragraph (CRM1) or paragraph (CRM2), may be further encoded with additional instructions which, when executed by the at least one processor, may further cause the at least one processor to determine that the content includes an image, determine a size of the image being presented by a display component of the computing device, and determine the threshold distance based at least in part on the size of the image.

(CRM4) At least one non-transitory, computer-readable medium may be encoded with instructions as described in any of paragraphs (CRM1) through (CRM3), wherein the received input from the computing device includes data from an image capture device of the computing device, and the computer-readable medium may be further encoded with additional instructions which, when executed by the at least one processor, may further cause the at least one processor to determine one or more authorized persons to access the content, retrieve images of the authorized persons, process the images of the authorized persons and the received data from the image capture device to determine that the at least one other person represented in the received data is unauthorized to access the file, and cause the computing device to output an indication informing the user of the at least one other person capable of accessing the content of the file in response to the determination that the at least one person is unauthorized to access the file and the determination of the at least one person being within the threshold distance of the computing device.

(CRM5) At least one non-transitory, computer-readable medium may be encoded with instructions as described in any of paragraphs (CRM1) through (CRM4), and may be further encoded with additional instructions which, when executed by the at least one processor, may further cause the at least one processor to identify that the computing device is located within a geographic area associated with a work environment of the user, and determine the authorized persons to access the content in response to identifying that the computing device is located within the geographic area.

(CRM6) At least one non-transitory, computer-readable medium may be encoded with instructions as described in any of paragraphs (CRM1) through (CRM5), and may be further encoded with additional instructions which, when executed by the at least one processor, may further cause the at least one processor to receive a user input from the computing device in response to the computing device modifying the output of the file, where the user input is indicative approval from the user to continue outputting the content of the file, receive additional input from the computing device indicative of at least one additional person proximate to the computing device, determine that the at least one additional person is within the threshold distance of the computing device, determine authorized persons to access the content, retrieve images of the authorized persons, process the images of the authorized persons and the received additional input to determine that the at least one additional person is authorized to access the content, and cause the computing device to continue outputting the content based at least in part on the at least one additional person being authorized to access the content.

(CRM7) At least one non-transitory, computer-readable medium may be encoded with instructions as described in any of paragraphs (CRM1) through (CRM6), and may be further encoded with additional instructions which, when executed by the at least one processor, may further cause the at least one processor to detect that the content is designated as secure, and receive the input from the computing device based at least in part on the detection of the content being designated as secure.

(CRM8) At least one non-transitory, computer-readable medium may be encoded with instructions as described in any of paragraphs (CRM1) through (CRM7), and may be further encoded with additional instructions which, when executed by the at least one processor, further cause the at least one processor to determine that the content includes audio, determine an output volume being used to output the audio via at least one speaker of the computing device, and determine the threshold distance based at least in part on the output volume.

(CRM9) At least one non-transitory, computer-readable medium may be encoded with instructions as described in any of paragraphs (CRM1) through (CRM8), and may be further encoded with additional instructions which, when executed by the at least one processor, may further cause the at least one processor to cause the computing device to output an audio warning using the speaker of the computing device, the audio warning informing the user that the at least one person proximate to the computing device is capable of receiving the audio.

(CRM10) At least one non-transitory, computer-readable medium may be encoded with instructions which, when executed by at least one processor included in a first computing system, cause the at least one processor to receive data via an image capture device of a computing device in response to a request to access a file, where the data indicative of at least one other person proximate to the computing device, the at least one person being in addition to a user of the computing device, determine at least one authorized person in addition to the user, the at least one authorized person authorized to access the file, receive an image of the at least one authorized person, process the received data from the image capture device of the computing device and the image of the at least one authorized person to determine that the at least one person is unauthorized to access the file, and modify an output of the computing device in response to the determination that the at least one person is unauthorized to access the file, so as to inhibit receipt of the file by the at least one person.

(CRM11) At least one non-transitory, computer-readable medium may be encoded with instructions as described in paragraph (CRM10), may be further encoded with additional instructions which, when executed by the at least one processor, may further cause the at least one processor to receive an input from the computing device in response to modifying the output of the computing device, where the input is indicative of an approval from the user to continue outputting the content of the file, receive additional data via the image capture device of the computing device, where the additional data indicative of at least one additional person proximate to the computing device in addition to the user, the additional data being captured after receiving the input, process the received additional data from the image capture device of the computing device and the image of the at least one authorized person to determine that the at least one additional person is authorized to access the file, and cause the computing device to continue outputting the file in response to the determination that the at least one additional other person is authorized to access the file.

(CRM12) At least one non-transitory, computer-readable medium may be encoded with instructions as described in any of paragraphs (CRM10) or (CRM11), may be further encoded with additional instructions which, when executed by the at least one processor, may further cause the at least one processor to determine, using the received data from the image capture device, a distance of the at least one person from the computing device, determine that the distance of the at least one person is within a threshold distance from the computing device, and wherein processing the received data from the image capture device and the image of the at least one authorized person is performed in response to the determination that the at least one person is within the threshold distance from the computing device.

(CRM13) At least one non-transitory, computer-readable medium may be encoded with instructions as described in any of paragraphs (CRM10) through (CRM12), may be further encoded with additional instructions which, when executed by the at least one processor, may further cause the at least one processor to identify that the computing device is located within a geographic area associated with a work environment of the user, and determine the at least one authorized person to access the file in response to identifying that the computing device is located within the geographic area.

(CRM14) At least one non-transitory, computer-readable medium may be encoded with instructions as described in any of paragraphs (CRM10) through (CRM13), may be further encoded with additional instructions which, when executed by the at least one processor, may further cause the at least one processor to determine accessibility of the file based on the manner of output of the file, and determine a threshold distance from the computing device based on the accessibility of the file, where the threshold distance is indicative of a distance within which the at least one person is capable of receiving contents of the file.

(CRM15) At least one non-transitory, computer-readable medium may be encoded with instructions as described in any of paragraphs (CRM10) through (CRM14), may be further encoded with additional instructions which, when executed by the at least one processor, may further cause the at least one processor to determine that the file includes text and an image, determine the accessibility of the file based on a font size of the text being presented by a display component of the computing device and a size of the image being presented by a display component of the computing device, and modify the output of the computing device by outputting a message using the display component of the computing device in response to the determination that the at least one person is within the threshold distance from the computing device, where the message informs the user that the at least one person is capable of accessing contents of the file.

(CRM16) At least one non-transitory, computer-readable medium may be encoded with instructions as described in any of paragraphs (CRM10) through (CRM14), may be further encoded with additional instructions which, when executed by the at least one processor, may further cause the at least one processor to determine that the file includes audio, determine the accessibility of the file based on the audio being outputted using a speaker of the computer device and an output volume being used to output the audio, and cause the computer device to output an audio warning using the speaker of the computing device in response to the determination that the at least one person is within the threshold distance from the computing device, where the audio warning informs the user that the at least one other person proximate to the computing device is capable of receiving the audio.

(CRM17) At least one non-transitory, computer-readable medium may be encoded with instructions as described in any of paragraphs (CRM10) through (CRM16), may be further encoded with additional instructions which, when executed by the at least one processor, may further cause the at least one processor to detect that the file is designated as secure, and receive the data from the image capture device in response to the detection that the file is designated as secure.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
receiving, from a computing device, an input indicative of at least one person proximate to the computing device, the at least one person being different than a user of the computing device;
determining that the at least one person is within a threshold distance from the computing device based on the received input; and
modifying an output of the computing device in response to the determination of the at least one person being within the threshold distance from the computing device, so as to inhibit receipt of content from the computing device by the at least one person.

2. The method of claim 1, further comprising:
determining that the content includes text;
determining a font size of the text being presented by a display component of the computing device; and
determining the threshold distance based at least in part on the font size.

3. The method of claim 1, further comprising:
determining that the content includes an image;
determining a size of the image being presented by a display component of the computing device; and
determining the threshold distance based at least in part on the size of the image.

4. The method of claim 1, wherein the received input from the computing device includes data from an image capture device of the computing device, and the method further comprises:
determining one or more authorized persons to access the content;
retrieving images of the authorized persons;
processing the images of the authorized persons and the received data to determine that the at least one other person represented in the received data is unauthorized to access the file; and
causing the computing device to output an indication informing the user of the at least one other person capable of accessing the content in response to the determination that the at least one person is unauthorized to access the file and the determination of the at least one person being within the threshold distance of the computing device.

5. The method of claim 4, further comprising:
identifying that the computing device is located within a geographic area associated with a work environment of the user; and
determining the authorized persons to access the content based at least in part on the computing device being located within the geographic area.

6. The method of claim 1, further comprising:
receiving a user input provided to the computing device after the computing device modifies the output of the computing device, the user input indicating approval from the user to continue outputting the content;
receiving, from the computing device, additional input indicative of at least one additional person proximate to the computing device;
determining that the at least one additional person is within the threshold distance of the computing device;
determining authorized persons to access the content;
processing images of the authorized persons and the received additional input to determine that the at least one additional person is authorized to access the content; and
causing the computing device to continue outputting the content based at least in part on the at least one additional person being authorized to access the content.

7. The method of claim 1, further comprising:
detecting that the content is designated as secure; and
receiving the input from the computing device based at least in part on the detection of the content being designated as secure.

8. The method of claim 1, further comprising:
determining that the content includes audio;
determining an output volume being used to output the audio via at least one speaker of the computing device; and
determining the threshold distance based at least in part on the output volume.

9. The method of claim 8, further comprising:
causing the computing device to output an audio warning using the at least one speaker, the audio warning informing the user that the at least one person proximate to the computing device is capable of receiving the audio.

10. A system, comprising:
at least one processor; and
at least one computer-readable medium encoded with instructions which, when executed by the at least one processor, cause the system to:
receive, from a computing device, an input indicative of at least one person proximate to the computing device, the at least one person being different than a user of the computing device;
determine that the at least one person is within a threshold distance from the computing device based on the received input; and
modify an output of the computing device in response to the determination of the at least one person being within the threshold distance from the computing device, so as to inhibit receipt of content from the computing device by the at least one person.

11. The system of claim 10, wherein the computer-readable medium is encoded with additional instructions which, when executed by the at least one processor, further cause the system to:
determine that the content includes text;
determine a font size of the text being presented by a display component of the computing device; and
determine the threshold distance based at least in part on the font size.

12. The system of claim 10, wherein the computer-readable medium is encoded with additional instructions which, when executed by the at least one processor, further cause the system to:
determine that the content includes an image;
determine a size of the image being presented by a display component of the computing device; and
determine the threshold distance based at least in part on the size of the image.

13. The system of claim 10, wherein the computer-readable medium is encoded with additional instructions which, when executed by the at least one processor, further cause the system to:
determine that the content comprises audio;
determine an output volume being used to output the audio via at least one speaker of the computing device; and
determine the threshold distance based at least in part on the output volume.

14. A method, comprising:
receiving data via an image capture device of a computing device in response to a request to access a file, the data indicative of at least one person proximate to the computing device, the at least one person in addition to a user of the computing device;
determining, by the computing system, at least one authorized person in addition to the user, the at least one authorized person authorized to access the file;
receiving an image of the at least one authorized person;
processing the received data from the image capture device of the computing device and the image of the at least one authorized person to determine that the at least one person is unauthorized to access the file; and
modifying an output of the computing device in response to the determination that the at least one person is unauthorized to access the file, so as to inhibit receipt of the file by the at least one person.

15. The method of claim 14, further comprising:
receiving an input from the computing device in response to modifying the output of the computing device, the input indicative of an approval from the user to continue outputting the file;
receiving additional data via the image capture device of the computing device, the additional data indicative of at least one additional person proximate to the computing device in addition to the user, the additional data being captured after receiving the input;
processing the received additional data from the image capture device of the computing device and the image of the at least one authorized person to determine that the at least one additional person is authorized to access the file; and
causing the computing device to continue outputting the file in response to the determination that the at least one additional other person is authorized to access the file.

16. The method of claim 14, further comprising:
determining, using the received data from the image capture device, a distance of the at least one person from the computing device;
determining that the distance of the at least one person is within a threshold distance from the computing device, and
wherein processing the received data from the image capture device and the image of the at least one authorized person is performed in response to the determination that the at least one person is within the threshold distance from the computing device.

17. The method of claim 14, further comprising:
identifying that the computing device is located within a geographic area associated with a work environment of the user; and
determining the at least one authorized person to access the file in response to identifying that the computing device is located within the geographic area.

18. The method of claim 14, further comprising:
determining accessibility of the file based on the manner of output of the file; and
determining a threshold distance from the computing device based on the accessibility of the file, the threshold distance indicative of a distance within which the at least one person is capable of receiving contents of the file.

19. The method of claim 18, further comprising:
determining that the file includes text and an image;
determining the accessibility of the file based on a font size of the text being presented by a display component of the computing device and a size of the image being presented by a display component of the computing device; and
modifying the output of the computing device by outputting a message using the display component of the computing device in response to the determination that the at least one person is within the threshold distance from the computing device, the message informing the user that the at least one person is capable of accessing contents of the file.

20. The method of claim 18, further comprising:
determining that the file includes audio;
determining the accessibility of the file based on the audio being outputted using a speaker of the computer device and an output volume being used to output the audio; and
causing the computer device to output an audio warning using the speaker of the computing device in response to the determination that the at least one person is within the threshold distance from the computing device, the audio warning informing the user that the at least one person proximate to the computing device is capable of receiving the audio.
